(19) United States
(12) Patent Application Publication
(10) Pub. No.: US 2017/0206661 A1
(43) Pub. Date: Jul. 20, 2017

(54) IMAGE PROCESSING APPARATUS, IMAGE PROCESSING METHOD, IMAGE PROCESSING SYSTEM, AND NON-TRANSITORY COMPUTER READABLE MEDIUM

(71) Applicant: FUJI XEROX CO., LTD., Tokyo (JP)

(72) Inventor: Makoto SASAKI, Kanagawa (JP)

(73) Assignee: FUJI XEROX CO., LTD., Tokyo (JP)

(21) Appl. No.: 15/249,538

(22) Filed: Aug. 29, 2016

(30) Foreign Application Priority Data
Jan. 15, 2016 (JP) 2016-006684

(51) Int. Cl. G06T 7/00; G06F 3/0488

(52) U.S. Cl. CPC G06T 7/0081; G06F 3/0488; G06T 2207/20144

(57) ABSTRACT

An image processing apparatus includes an image information obtaining unit, a position information obtaining unit, a first representative position setting unit, a second representative position setting unit, and a region detecting unit. The image information obtaining unit obtains image information about an image. The position information obtaining unit obtains position information about an inclusive region including a designated region, which is a specific image region in the image. The first representative position setting unit acquires a feature quantity of the designated region and sets a first representative position, which is a representative position of the designated region, in accordance with the feature quantity of the designated region. The second representative position setting unit sets a second representative position, which is a representative position of an outside region outside the designated region. The region detecting unit detects the designated region by using the first representative position and the second representative position.

### CROSS-REFERENCE TO RELATED APPLICATIONS

This application is based on and claims priority under 35 USC 119 from Japanese Patent Application No. 2016-006684 filed Jan. 15, 2016.

### BACKGROUND

(i) Technical Field

The present invention relates to an image processing apparatus, an image processing method, an image processing system, and a non-transitory computer readable medium.

(ii) Related Art

In the field of image processing, for example, the GraphCut method is available as a method for accurately cutting out a specific region. In the GraphCut method, a foreground region (a region to be cut out) and a background region (the other region) are separated from each other on the basis of a seed (a curve or the like) given thereto. Furthermore, the GrabCut method for cutting out a specific region has been developed on the basis of the principle of GraphCut, which enables a user to cut out a specific region only by encompassing a region to be cut out with a rectangle.

### SUMMARY

According to an aspect of the invention, there is provided an image processing apparatus including an image information obtaining unit, a position information obtaining unit, a first representative position setting unit, a second representative position setting unit, and a region detecting unit. The image information obtaining unit obtains image information about an image. The position information obtaining unit obtains position information about an inclusive region input by a user and including a designated region, the designated region being a specific image region in the image. The first representative position setting unit acquires a feature quantity of the designated region from image information about the inclusive region and sets a first representative position, which is a representative position of the designated region, in accordance with the feature quantity of the designated region. The second representative position setting unit sets a second representative position, which is a representative position of an outside region, the outside region being a region outside the designated region. The region detecting unit detects the designated region by using the first representative position and the second representative position.

### BRIEF DESCRIPTION OF THE DRAWINGS

Exemplary embodiments of the present invention will be described in detail based on the following figures, wherein:

FIG. 1 is a diagram illustrating an example configuration of an image processing system according to an exemplary embodiment;

FIG. 2 is a block diagram illustrating an example functional configuration of an image processing apparatus according to the exemplary embodiment;

FIGS. 3A and 3B are diagrams illustrating a first example of a method for designating a region in a user interactive manner;

FIGS. 4A to 4C are diagrams illustrating a second example of a method for designating a region in a user interactive manner;

FIG. 5 is a diagram illustrating a histogram of pixels in a foreground cover region;

FIG. 6 illustrates first representative positions set on an image;

FIG. 7 illustrates another method for acquiring a feature quantity;

FIG. 8 is a table describing frequencies for R, G, and B obtained through a subtractive color process;

FIGS. 9A and 9B are diagrams illustrating an example of a background cover region;

FIG. 10A illustrates a case where a foreground cover region does not cover an entire designated region and FIG. 10B illustrates a case where a GUI for intuitively operating a circumscribed rectangle is provided;

FIG. 10C illustrates a case where a user inputs a curve and FIG. 10D illustrates a case where a GUI for intuitively operating a circumscribed rectangle is provided;

FIG. 11 is a diagram illustrating a seed;

FIG. 12 is a diagram illustrating an example in which a seed is set also in a circumscribed rectangle in a case where the seed is acquired by including image information about the inside of the circumscribed rectangle of a foreground cover region;

FIG. 13 is a diagram illustrating a case where a rectangle is set on the outer side of the circumscribed rectangle of the foreground cover region as a region adjacent to the circumscribed rectangle, and the region between the edges of these rectangles is regarded as a seed;

FIG. 14 is a diagram illustrating the max-flow min-cut theorem;

FIG. 15 illustrates a state where a designated region and an outside region are cut out from the image illustrated in FIG. 3A by using a region growing method;

FIGS. 16A and 16B illustrate an example of a screen displayed on a display screen of a display apparatus when the user selects a designated region or outside region;

FIG. 17 illustrates an example of a screen displayed on the display screen of the display apparatus when image processing is performed;

FIG. 18 is a diagram illustrating a case where the user inputs plural foreground cover regions to an image;

FIG. 19 is a diagram illustrating an example of switching between regions by using radio buttons;

FIG. 20 is a diagram illustrating a case where there are plural circumscribed rectangles;

FIG. 21 illustrates an example in which a first representative position setting unit and a second representative position setting unit set seeds;

FIG. 22 illustrates a case where two circumscribed rectangles overlap each other;

FIG. 23 is a diagram illustrating a case where the region other than circumscribed rectangles is set as a seed;

FIG. 24 illustrates a state where designated regions and an outside region are cut out from the image illustrated in FIG. 18 by using a region growing method;

FIG. 25 is a block diagram illustrating an example functional configuration of a region detecting unit according to the exemplary embodiment;

FIG. 26A illustrates an original image in which a designated region is to be cut out and FIG. 26B illustrates reference pixels;

FIG. 27 is a diagram illustrating first ranges;

FIG. 28 illustrates a result of determination performed on target pixels belonging to the first ranges illustrated in FIG. 27 on the basis of a Euclidean distance;

FIGS. 29A and 29B are graphs illustrating a method for determining influence;

FIG. 30 illustrates a result of determination performed on target pixels belonging to the first ranges illustrated in FIG. 27 on the basis of intensity;

FIGS. 31A to 31H are diagrams illustrating an example of a process of sequentially labeling pixels by using a region growing method based on intensity;

FIGS. 32A to 32H are diagrams illustrating an example of a process of sequentially labeling pixels by using a region growing method according to a second example;

FIGS. 33A and 33B are diagrams illustrating a case where the order of the row and column is inverted;

FIG. 34 is a flowchart illustrating an operation of the region detecting unit according to first and second examples;

FIG. 35 is a diagram illustrating a target pixel selected by a pixel selecting unit and a second range set by a range setting unit;

FIG. 36 is a diagram illustrating a result of determination according to the exemplary embodiment;

FIGS. 37A to 37H are diagrams illustrating an example of a process of sequentially labeling pixels by using a region growing method according to a fourth example;

FIG. 38 is a flowchart illustrating an operation of the region detecting unit according to third and fourth examples;

FIG. 39 is a flowchart illustrating an operation of the region detecting unit according to a fifth example;

FIG. 40 is a flowchart illustrating an operation of the image processing apparatus; and

FIG. 41 is a diagram illustrating the hardware configuration of the image processing apparatus.

### DETAILED DESCRIPTION

Hereinafter, exemplary embodiments of the present invention will be described in detail with reference to the attached drawings.

### Description of Overall Image Processing System

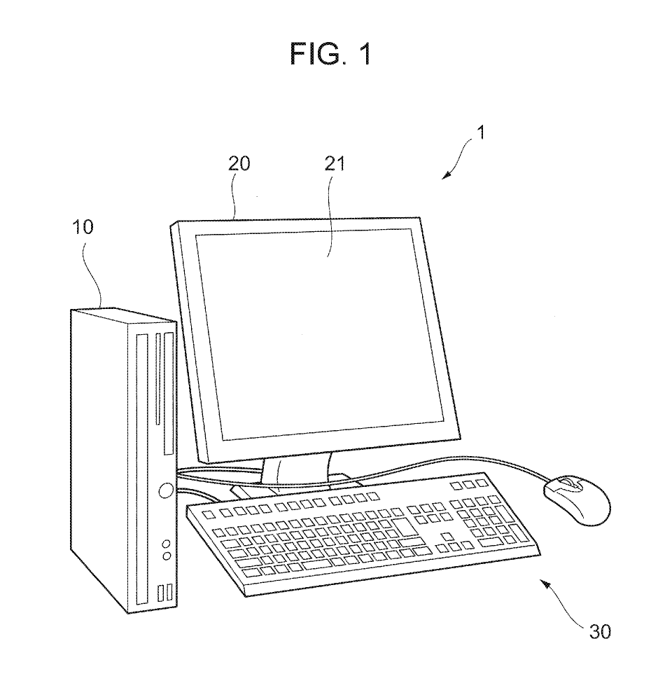

FIG. 1 is a diagram illustrating an example configuration of an image processing system 1 according to an exemplary embodiment.

As illustrated in FIG. 1, the image processing system 1 includes an image processing apparatus 10, a display apparatus 20, and an input apparatus 30. The image processing apparatus 10 performs image processing on image information about an image to be displayed on the display apparatus 20. The display apparatus 20 receives image information created by the image processing apparatus 10 and displays an image on the basis of the image information. The input apparatus 30 is used by a user to input various pieces of information to the image processing apparatus 10.

The image processing apparatus 10 is, for example, a so-called general-purpose personal computer (PC). The image processing apparatus 10 operates various types of application software under control by an operating system (OS), and thereby creates image information.

The display apparatus 20 displays an image on a display screen 21. The display apparatus 20 is formed of a device having a function of displaying an image by using additive color mixing, such as a liquid crystal display for a PC, a liquid crystal television display, or a projector. The display method used in the display apparatus 20 is not limited to a liquid crystal method. In the example illustrated in FIG. 1, the display screen 21 is provided in the display apparatus 20. In a case where a projector is used as the display apparatus 20, for example, a screen or the like provided outside the display apparatus 20 serves as the display screen 21.

The input apparatus 30 is formed of a keyboard, a mouse, and the like. The input apparatus 30 is used to start or end application software for performing image processing, and to input, by a user, an instruction to perform image processing to the image processing apparatus 10, which will be described in detail below.

The image processing apparatus 10 and the display apparatus 20 are connected to each other via a digital visual interface (DVI). Alternatively, the image processing apparatus 10 and the display apparatus 20 may be connected to each other via a high definition multimedia interface (HDMI, registered trademark), DisplayPort, or the like, instead of the DVI.

The image processing apparatus 10 and the input apparatus 30 are connected to each other via, for example, a universal serial bus (USB). Alternatively, the image processing apparatus 10 and the input apparatus 30 may be connected to each other via IEEE 1394, RS-232C, or the like instead of the USB.

In the image processing system 1, the display apparatus 20 first displays an original image, which is an image that has not been subjected to image processing. When the user inputs an instruction to perform image processing to the image processing apparatus 10 by using the input apparatus 30, the image processing apparatus 10 performs image processing on the image information about the original image. The result of the image processing is reflected in the image displayed on the display apparatus 20. Accordingly, the image that has been subjected to image processing is redrawn and displayed on the display apparatus 20. In this case, the user may be able to interactively perform image processing while viewing the image displayed on the display apparatus 20 and to perform operations of image processing more intuitively and more easily.

The image processing system 1 according to the exemplary embodiment is not limited to the form illustrated in FIG. 1. For example, a tablet terminal may be used as the image processing system 1. In this case, the tablet terminal includes a touch panel, which displays an image and receives a user instruction. That is, the touch panel functions as the display apparatus 20 and the input apparatus 30. Also, a touch monitor may be used as an apparatus in which the display apparatus 20 and the input apparatus 30 are integrated together. This is implemented by using a touch panel as the display screen 21 of the display apparatus 20. In this case, image information is created by the image processing apparatus 10, and an image is displayed on the touch monitor on the basis of the image information. The user touches the touch monitor to input an instruction to perform image processing.

### Description of Image Processing Apparatus

### First Exemplary Embodiment

Next, the image processing apparatus 10 according to a first exemplary embodiment will be described.

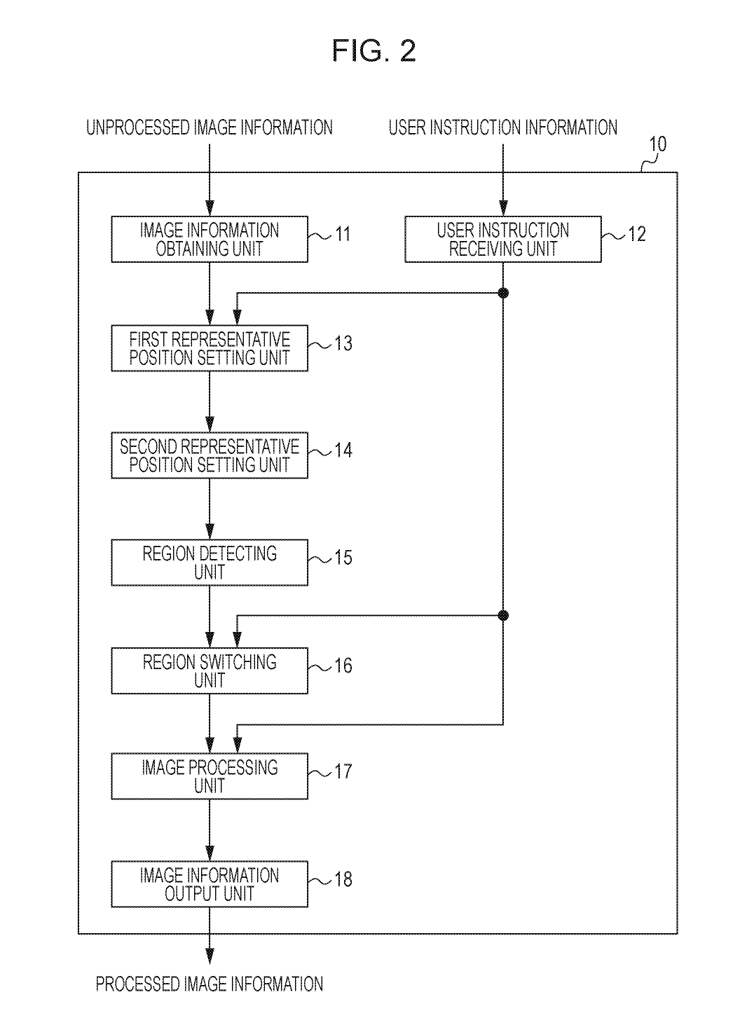

FIG. 2 is a block diagram illustrating an example functional configuration of the image processing apparatus 10 according to the first exemplary embodiment of the present invention. FIG. 2 selectively illustrates the functions related to the first exemplary embodiment among various functions of the image processing apparatus 10.

As illustrated in FIG. 2, the image processing apparatus 10 according to the first exemplary embodiment includes an image information obtaining unit 11, a user instruction receiving unit 12, a first representative position setting unit 13, a second representative position setting unit 14, a region detecting unit 15, a region switching unit 16, an image processing unit 17, and an image information output unit 18.

The image information obtaining unit 11 obtains image information about an image on which image processing is to be performed. In other words, the image information obtaining unit 11 obtains image information that has not been subjected to image processing. The image information is, for example, RGB (red, green, blue) video data (RGB data) that is to be used for display on the display apparatus 20.

The user instruction receiving unit 12 is an example of a position information obtaining unit and receives a user instruction about image processing input through the input apparatus 30.

Specifically, the user instruction receiving unit 12 receives, as user instruction information, an instruction to designate a region, which is an image region to be subjected to image processing, in the image displayed on the display apparatus 20. More specifically, in this exemplary embodiment, the user instruction receiving unit 12 obtains, as user instruction information, position information about a foreground cover region input by the user and including the designated region, which is a specific image region in the image.

Although the details will be described below, the user instruction receiving unit 12 receives, as user instruction information, an instruction to select a region to be actually subjected to image processing from the designated region. Furthermore, the user instruction receiving unit 12 receives, as user instruction information, an instruction about an item and amount of image processing to be performed on the selected region. Further details about this will be described below.

This exemplary embodiment employs a method for designating a region in a user interactive manner, which will be described below.

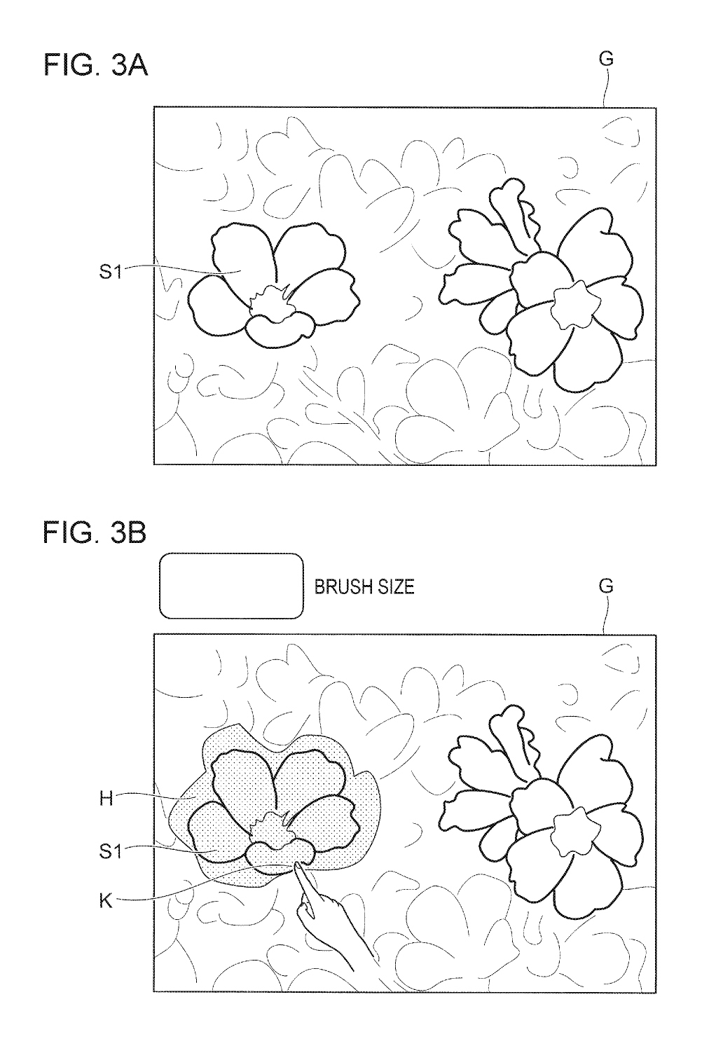

FIGS. 3A and 3B are diagrams illustrating a first example of the method for designating a region in a user interactive manner.

FIG. 3A illustrates an image that has not been subjected to image processing, that is, an image G displayed on the display apparatus 20 on the basis of image data obtained by the image information obtaining unit 11. The image G is a photo image captured by photographing part of a field, specifically, flowers and leaves of plants. FIG. 3B illustrates a case where the user selects a portion of a flower on the left, which is in the foreground, as a “designated region S1”. Hereinafter, the region outside the designated region S1, which is in the background, may be referred to as an “outside region S2”.

The user inputs, with respect to the image G, a foreground cover region H including the designated region S1. Specifically, the user creates a trail K to encompass a region including the flower portion corresponding to the designated region S1 and a surrounding region thereof on the image G, and thereby inputs the foreground cover region H including the designated region S1. In this case, the foreground cover region H is the total region of the flower portion corresponding to the designated region S1 and the surrounding region thereof. The foreground cover region H is an example of an inclusive region.

The trail K may be created by using the input apparatus 30. For example, in a case where the input apparatus 30 is a mouse, the user drags the mouse pointer on the image G displayed on the display screen 21 of the display apparatus 20 and thereby creates the trail K. In a case where the input apparatus 30 is a touch panel, the user moves his/her finger or a touch pen on the image G to create the trail K.

In this case, the foreground cover region H is input by the user by filling-in the designated region S1 and the region around the designated region S1 in the image G. The trail K is not necessarily created at one time, and may be created over plural times. That is, the foreground cover region H may be input through a user creating plural trails K on the image G.

The trail K is not limited to one created in one direction and may be created by a reciprocating motion. Creating the trail K with a bold line rather than a thin line makes it easier to input the foreground cover region H. This may be realized by, for example, installing a brush tool with a large brush size that is used in image processing software or the like for performing image processing.

To input the foreground cover region H, the user may create the trail K to encompass the foreground cover region H, instead of filling-in the foreground cover region H as illustrated in FIG. 3B.

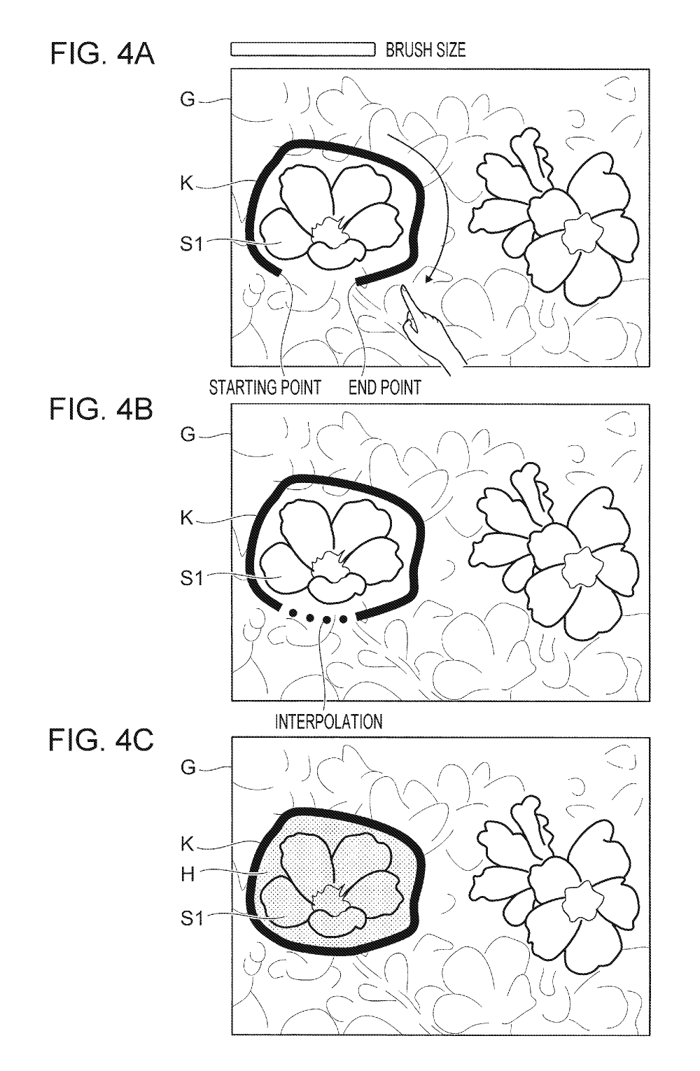

FIGS. 4A to 4C are diagrams illustrating a second example of the method for designating a region in a user interactive manner.

Here, the user creates the trail K to encompass the flower portion corresponding to the designated region S1 on the image G as illustrated in FIG. 4A, and thereby inputs the foreground cover region H including the designated region S1. The trail K illustrated in FIG. 4A is input clockwise in the figure from a starting point to an end point to encompass the flower portion.

In this case, the trail K may be a closed curve or may be an open curve that is illustrated in FIG. 4A. However, if the trail K formed of an open curve illustrated in FIG. 4A is input, it is necessary to make the open curve a closed curve.

FIG. 4B is a diagram illustrating a process of closing an open curve when the trail K formed of the open curve is input.

As illustrated in FIG. 4B, an interpolation process of connecting the starting point and the end point of the open curve is performed to make a closed curve. FIG. 4B illustrates a case where the starting point and the end point of the open curve are connected by a line segment represented by a broken line. This process may be easily performed by calculating an equation y=mx+n (m and n are constants) that expresses a straight line through the starting point and the end point. Here, the coordinates on the image of the starting point are expressed by (x, y)=(x₁, y₁), and the coordinates on the image of the end point are expressed by (x, y)=(x₂, y₂).

FIG. 4C is a diagram illustrating the foreground cover region H that is set when the trail K illustrated in FIG. 4A is input.

As illustrated in FIG. 4C, the closed curve generated through the interpolation illustrated in FIG. 4B and the inner region thereof correspond to the foreground cover region H.

Creating the trail K with a thin line rather than a bold line makes it easier to input the foreground cover region H. This may be realized by, for example, installing a brush tool with a thin to middle brush size that is used in image processing software or the like for performing image processing.

As illustrated in FIGS. 3A and 3B and FIGS. 4A to 4C, the foreground cover region H is input such that the outer periphery thereof is along the designated region S1 on its outer side.

The first representative position setting unit 13 acquires a feature quantity of the designated region S1 from the image information about the foreground cover region H and sets a first representative position, which is a representative position of the designated region S1, in accordance with the feature quantity of the designated region S1.

The feature quantity is color information representing a color that is representative of the colors forming the designated region S1 and is acquired as, for example, color information representing a color that is used more in the designated region S1. Also, the feature quantity represents the feature of the designated region S1 which is a foreground region. In this exemplary embodiment, the designated region S1 is a flower portion, and the color information representing the color of the flower is used as a feature quantity.

To acquire the feature quantity, the first representative position setting unit 13 first creates a histogram of the pixels in the foreground cover region H.

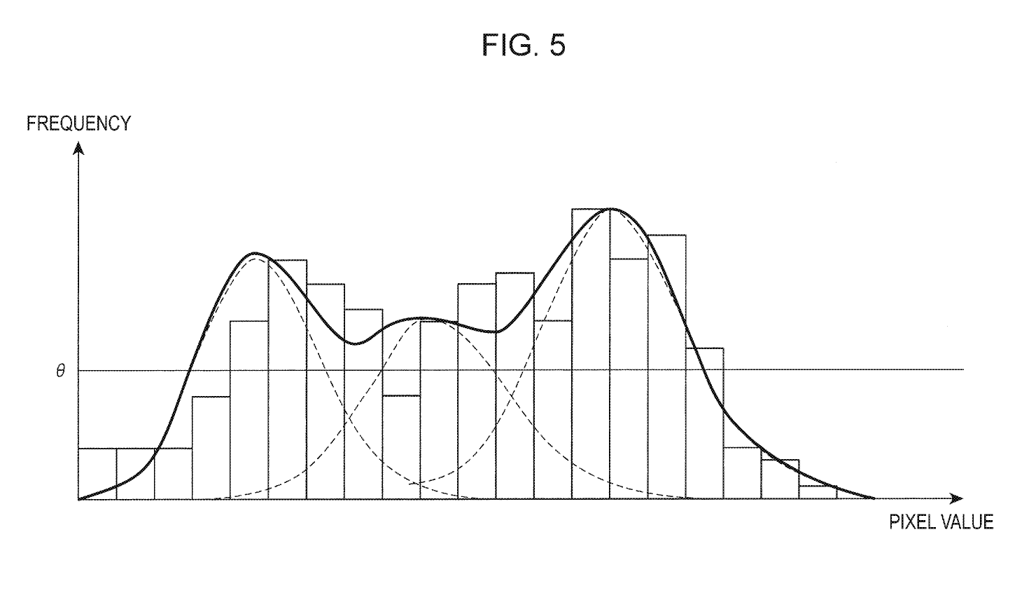

FIG. 5 is a diagram illustrating the histogram of the pixels in the foreground cover region H. In FIG. 5, the horizontal axis represents pixel value and the vertical axis represents frequency (the number of pixels). In a case where each pixel value is represented by a grayscale value of 8 bits, the pixel value takes an integer of 0 to 255. Regarding the frequency, normalization may be performed so that the total sum of all frequencies becomes 1.

Only one histogram is illustrated in FIG. 5, but three histograms are provided if the image G is a color image. For example, if the image data of the image G is RGB data, the first representative position setting unit 13 creates three histograms in which the horizontal axes represent R pixel value, G pixel value, and B pixel value, respectively.

Subsequently, the first representative position setting unit 13 performs function approximation on the created histogram in accordance with the sum of plural Gaussian functions by using the Gaussian Mixture Model (GMM). Function approximation using the GMM may be performed by combining the K-Means algorithm and the EM algorithm, which are widely used mathematical methods. In the example illustrated in FIG. 5, function approximation is performed on the histogram in accordance with the sum of three Gaussian functions represented by broken lines. The resulting function is referred to as a distributed approximating function D.

The first representative position setting unit 13 sets a threshold θ for the frequency of the distributed approximating function D. The first representative position setting unit 13 regards a pixel having a pixel value that is equal to or larger than the threshold θ as a first representative position, which is a representative position of the designated region S1. That is, a pixel value that takes a higher frequency is considered to be color information representing a representative color among the colors forming the designated region S1 and is thus regarded as a feature quantity. The pixel having the feature quantity is considered to be a representative position of the designated region S1, and thus the first representative position setting unit 13 regards this pixel as a first representative position, which is a representative position of the designated region S1.

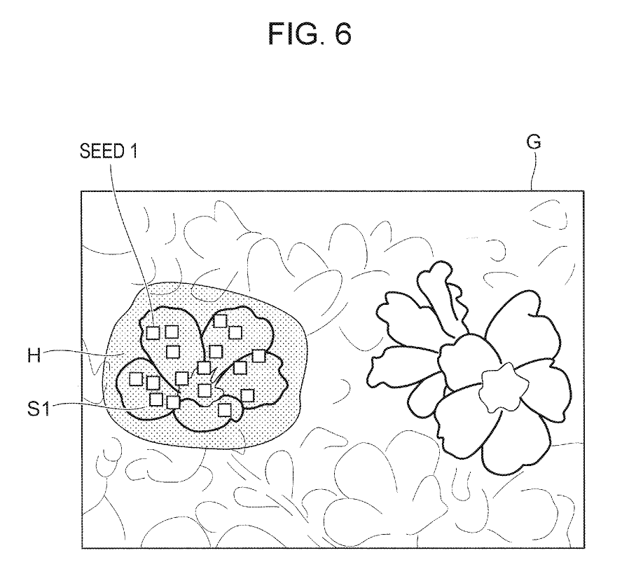

FIG. 6 illustrates first representative positions set on the image G.

In FIG. 6, each rectangular region corresponds to a first representative position. Hereinafter, the first representative position may be referred to as “seed 1”, as illustrated in FIG. 6. Seed 1 exists in the designated region S1, as illustrated in FIG. 6.

In this way, the first representative position setting unit 13 creates the histogram representing the frequency relative to the pixel value of the image information about the foreground cover region H, and sets a first representative position through comparison with the threshold that is set for the frequency.

The method used by the first representative position setting unit 13 to acquire a feature quantity is not limited to the method using the GMM.

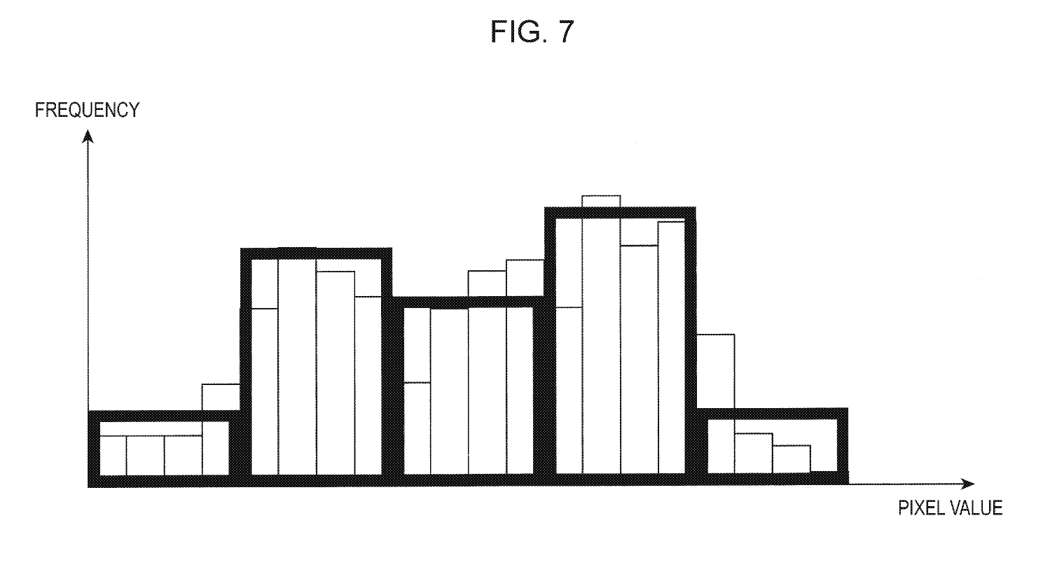

FIG. 7 is a diagram illustrating another method for acquiring a feature quantity.

FIG. 7 conceptually illustrates a histogram subjected to a subtractive color process. In this case, for example, pixel values that take integer values of 0 to 255 are divided into a predetermined number of sections, the frequencies are summed up in each section, and normalization is performed so that the total sum of all the frequencies becomes 1. Accordingly, the histogram is approximated.

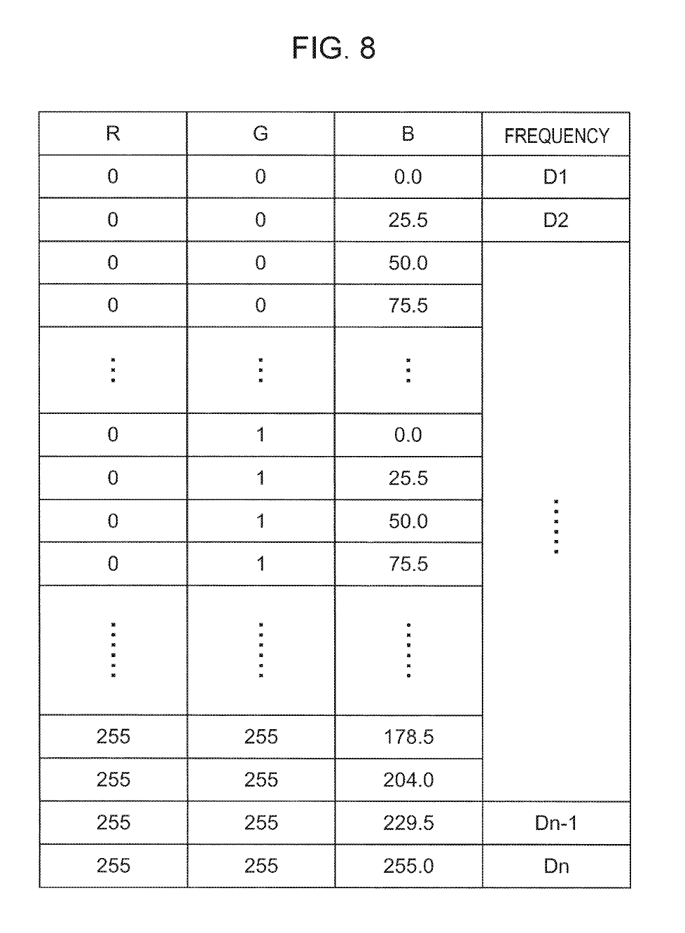

FIG. 8 is a table describing the frequencies for R, G, and B obtained through a subtractive color process.

In FIG. 8, frequencies are associated with each of R, G, and B. The frequencies are those at lattice points defined by the values of R, G, and B. If the above-described threshold θ is set for the frequencies, a feature quantity may be acquired in a similar manner to the above-described case.

In FIG. 8, there are n frequencies (D₁ to Dₙ). If the number of sections of pixel values is ten, for example, pixel values of each of R, G, and B are divided into eleven sections, and thus n=11³.

Alternatively, the histogram may be smoothed by weighted averaging to obtain a smooth frequency. In this case, when the frequency newly obtained at the n-th lattice point is represented by D_{wn}, smoothing may be carried out by calculating the weighted average equation expressed by Equation 1. Here, k represents a lattice point near n, and wₖ represents a weight added to the lattice point k. The value of wₖ may decrease as the distance from n increases.

$${D}_{wn} = \frac{{\sum }_{k} {w}_{k} {D}_{k}}{{\sum }_{k} {w}_{k}} \qquad Equation 1$$

The second representative position setting unit 14 sets a second representative position, which is a representative position of the outside region S2.

First, the second representative position setting unit 14 sets a background cover region J in accordance with the foreground cover region H.

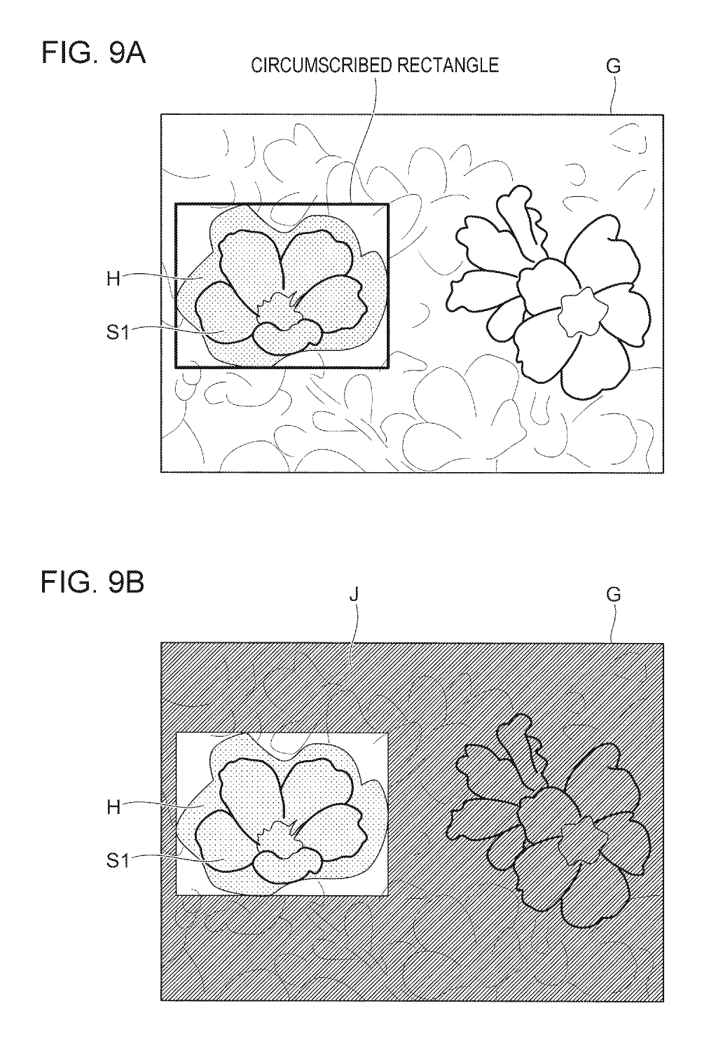

FIGS. 9A and 9B are diagrams illustrating an example of the background cover region J.

In the above-described example, the foreground cover region H covers the entire designated region S1. Thus, for example, the second representative position setting unit 14 acquires a circumscribed rectangle for the foreground cover region H as illustrated in FIG. 9A, and regards the entire region other than the inside of the circumscribed rectangle as the background cover region J, as illustrated in FIG. 9B.

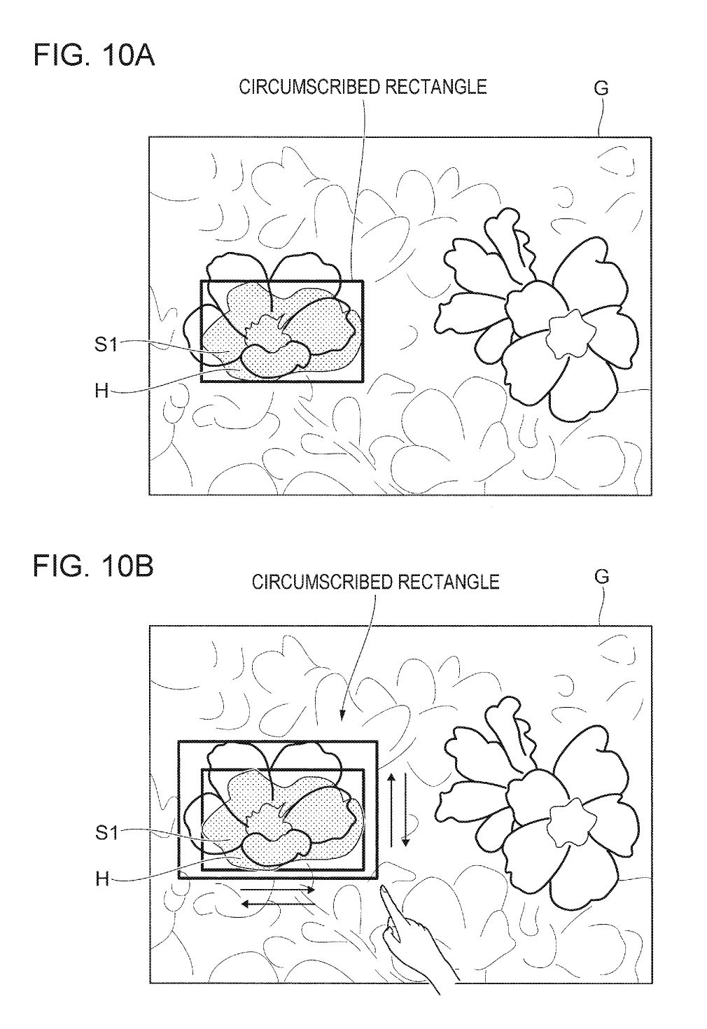

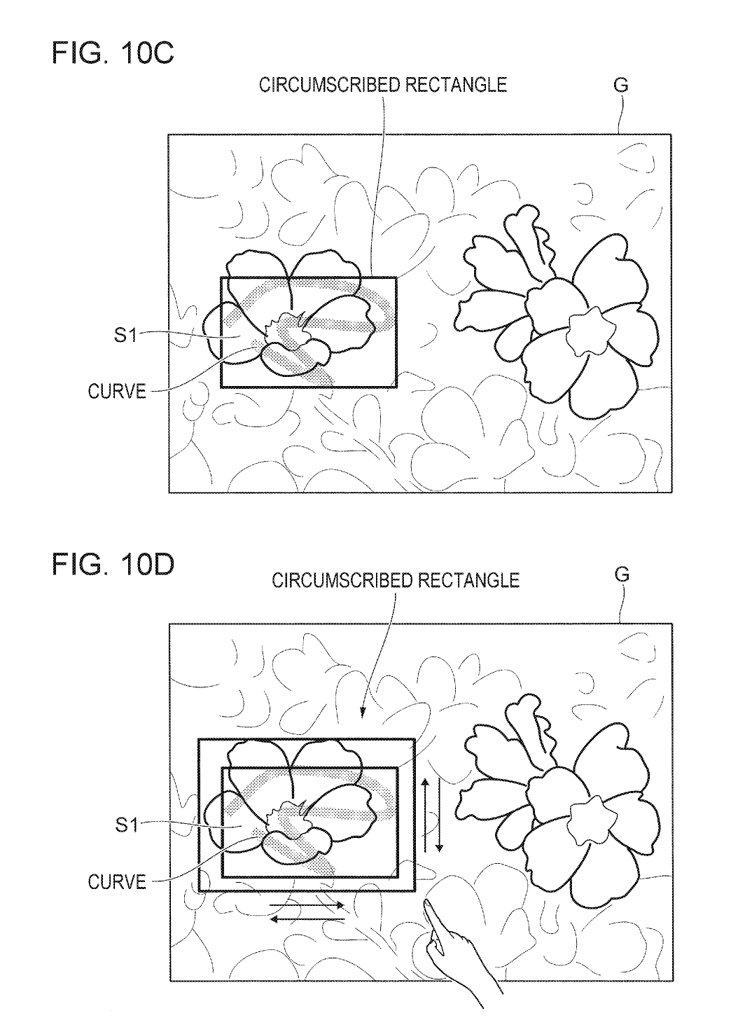

Even in a case where the foreground cover region H does not cover the entire designated region S1 as in FIG. 10A, a graphical user interface (GUI) for intuitively operating the circumscribed rectangle illustrated in FIG. 10B may be provided to interactively prevent the background cover region J from being covered by the designated region S1.

In FIG. 10B, in a case where the input apparatus 30 is a mouse, the user drags the circumscribed rectangle by operating the mouse so as to change the position or size of the circumscribed rectangle. In a case where the input apparatus 30 is a touch panel, the user moves the circumscribed rectangle by using his/her finger or a touch pen so as to change the position or size of the circumscribed rectangle in a similar manner.

Furthermore, the user may designate a region more roughly, for example, by inputting a curve so as to acquire a circumscribed rectangle for the curve, as illustrated in FIG. 10C. Also in this case, a GUI for intuitively operating the circumscribed rectangle illustrated in FIG. 10D may be provided to interactively prevent the background cover region J from being covered by the designated region S1.

Subsequently, the second representative position setting unit 14 sets a second representative position, which is a representative position of the outside region S2, in the background cover region J.

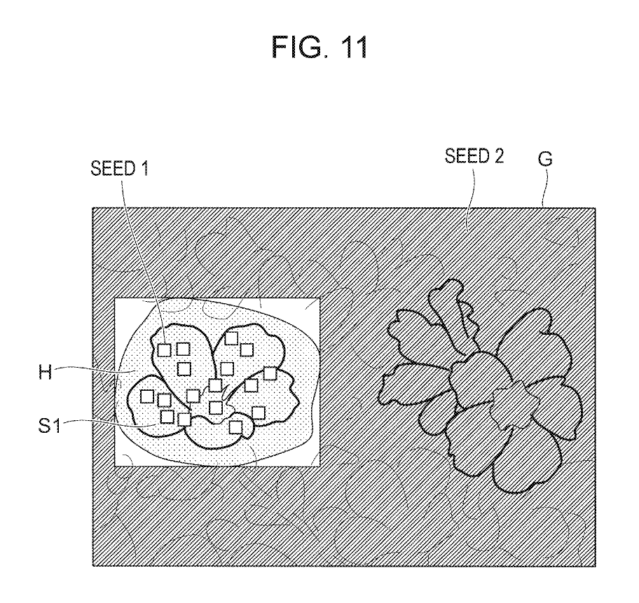

When it is sure that the region other than the inside of the circumscribed rectangle is the outside region S2, the background cover region J may be regarded as a second representative position. Hereinafter, the second representative position may be referred to as “seed 2”, as illustrated in FIG. 11.

The second representative position setting unit 14 may acquire a feature quantity of the outside region S2 from the image information about the region other than the foreground cover region H and may set a second representative position in accordance with the feature quantity of the outside region S2. Specifically, like the first representative position setting unit 13, the second representative position setting unit 14 creates a histogram, like the one illustrated in FIG. 5, of the pixels in the outside region S2. Subsequently, the second representative position setting unit 14 performs function approximation on the created histogram in accordance with the sum of plural Gaussian functions by using the GMM, and obtains a distributed approximating function D. The second representative position setting unit 14 then sets a threshold θ for the frequency of the distributed approximating function D. Furthermore, the second representative position setting unit 14 regards a pixel having a pixel value that is equal to or larger than the threshold θ as a second representative position, which is a representative position of the outside region S2.

In this case, the second representative position setting unit 14 may acquire the feature quantity of the outside region S2 from the image information about the region other than the inside of the circumscribed rectangle of the foreground cover region H.

Also, the second representative position setting unit 14 may acquire seed 2 by including the image information about the inside of the circumscribed rectangle of the foreground cover region H.

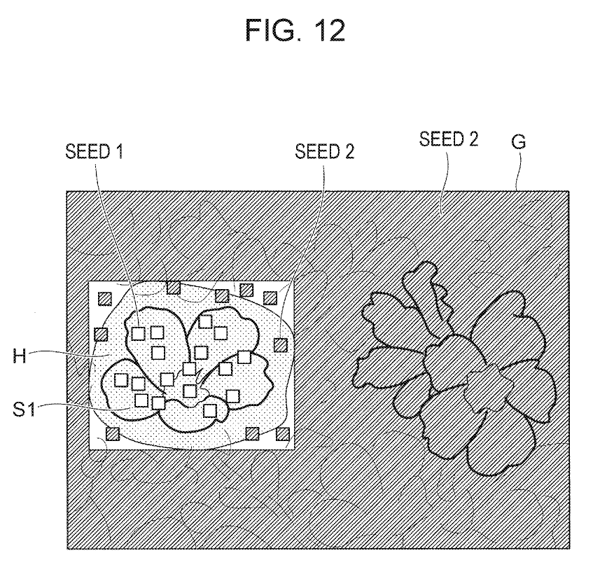

FIG. 12 illustrates an example in which seed 2 is set also in the circumscribed rectangle in a case where seed 2 is acquired by including the image information about the inside of the circumscribed rectangle of the foreground cover region H.

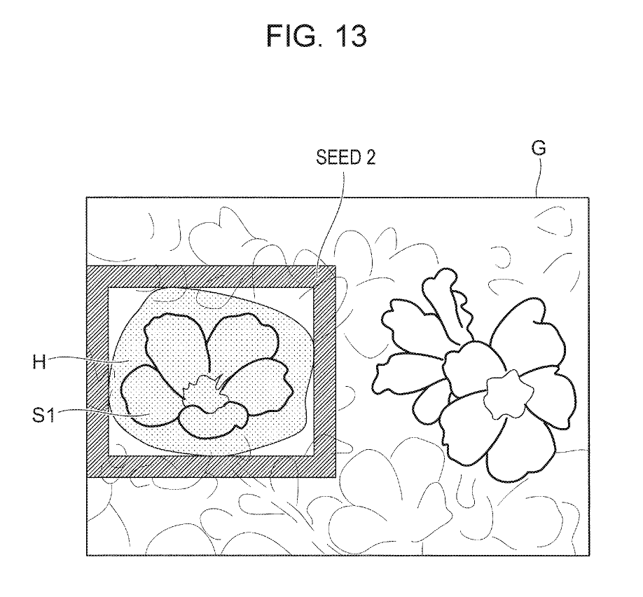

Furthermore, the second representative position setting unit 14 may regard the region adjacent to the circumscribed rectangle of the foreground cover region H as seed 2. For example, in FIG. 13, a rectangle is further set on the outer side of the circumscribed rectangle of the foreground cover region H as a region adjacent to the circumscribed rectangle, and the region between the edges of these rectangles is regarded as seed 2.

The region detecting unit 15 detects the designated region S1 by using the first representative position and the second representative position. Actually, the region detecting unit 15 performs a process of cutting out the designated region S1 from the image displayed on the display apparatus 20.

To cut out the designated region S1, the region detecting unit 15 may use, for example, a method based on the max-flow min-cut theorem by regarding the image G as a graph.

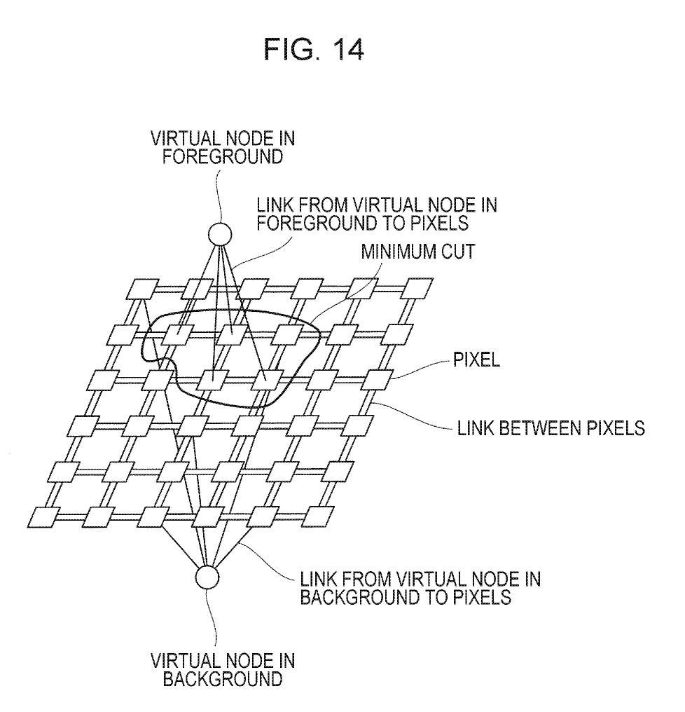

In this theorem, as illustrated in FIG. 14, a virtual node in the foreground is set as a starting point, a virtual node in the background is set as an end point, the virtual node in the foreground is linked to first representative positions of the designated region S1, and second representative positions of the outside region S2 are linked to the end point. The maximum flow that would be obtained when water runs from the starting point is calculated. That is, the value of the link from the first representative positions to the starting point is regarded as the diameter of a water pipe, and the total sum of cuts at bottlenecks is regarded as the maximum flow. Cutting the links as bottlenecks separates the foreground and background from each other (GraphCut).

In this case, the diameter of the link may be changed by reflecting the value of frequency. That is, in this case, the diameter of the link is represented as likelihood by a multi-value of 0 to 1.

Alternatively, the region detecting unit 15 may cut out the designated region S1 by using a region growing method on the basis of seed information.

To cut out the designated region S1 on the basis of seed information, the region detecting unit 15 attaches labels to the pixels at the position where the seed is set. In the examples illustrated in FIGS. 11 to 13, the region detecting unit 15 attaches “label 1” to the pixels corresponding to the trail created on the flower portion (seed 1) and attaches “label 2” to the pixels corresponding to the portion other than the flower portion (seed 2).

In this exemplary embodiment, attaching labels in this manner is referred to as “labeling”.

Although the details will be described below, the region detecting unit 15 cuts out the designated region S1 by using the region growing method for growing a region by repeating an operation of coupling a pixel to which the seed is set and a neighboring pixel if the pixel values (for example, the Euclidean distance of RGB values) of these pixels are close to each other and not coupling the pixels if the pixel values thereof are not close to each other.

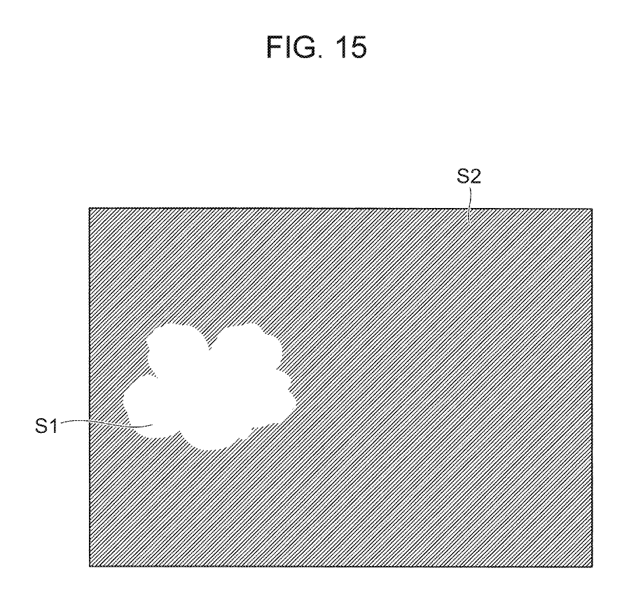

FIG. 15 illustrates a state where the designated region S1 and the outside region S2 have been cut out from the image G illustrated in FIG. 3A by using the region growing method.

With use of the above-described method, the user may be able to cut out the designated region S1 more intuitively and more easily even if the designated region S1 has a complicated shape.

The region switching unit 16 switches between the designated region S1 and the outside region S2. That is, the user selects the image region for which image adjustment is to be performed, and accordingly the region switching unit 16 switches the image region.

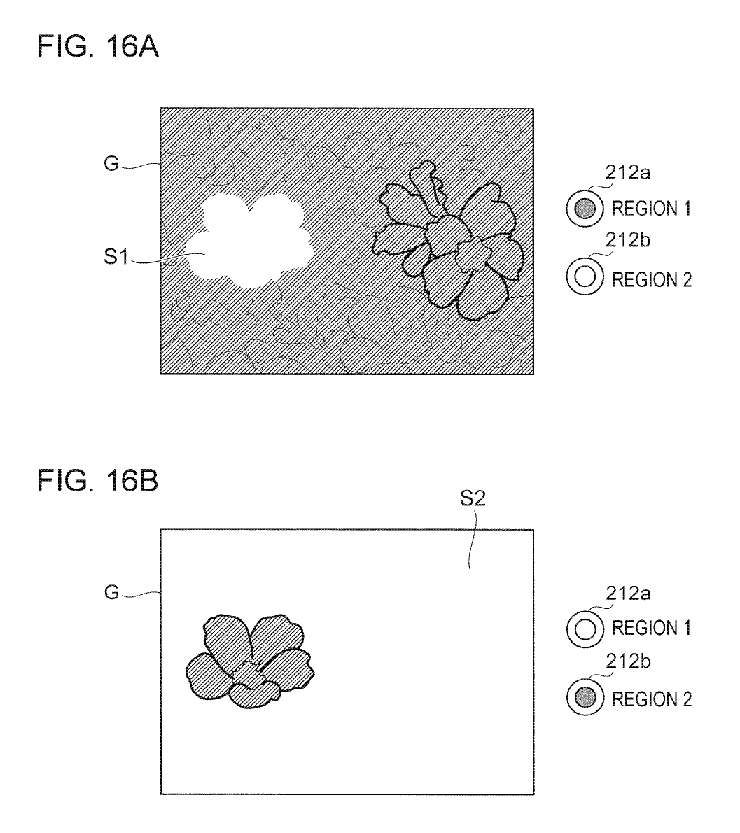

FIGS. 16A and 16B illustrate an example of a screen displayed on the display screen 21 of the display apparatus 20 when the user selects the designated region S1 or the outside region S2.

In the example illustrated in FIGS. 16A and 16B, the image G in a state where an image region is selected is displayed on the left side of the display screen 21, and radio buttons 212a and 212b to be used for selecting either of “region 1” and “region 2” are displayed on the right side of the display screen 21. In this case, “region 1” corresponds to the designated region S1 and “region 2” corresponds to the outside region S2. When the user selects either of the radio buttons 212a and 212b by using the input apparatus 30, the image region is switched.

FIG. 16A illustrates a state where the radio button 212a is selected and the designated region S1, which is an image region of a flower portion, is selected. When the user selects the radio button 212b, the image region is switched to the outside region S2, which is an image region other than the flower portion, as illustrated in FIG. 16B.

Actually, a result of the operation described in FIGS. 16A and 16B is obtained as user instruction information by the user instruction receiving unit 12, and the image region is switched to the designated region S1 or the outside region S2 by the region switching unit 16.

The image processing unit 17 actually performs image processing on the designated region S1 or the outside region S2 that has been selected.

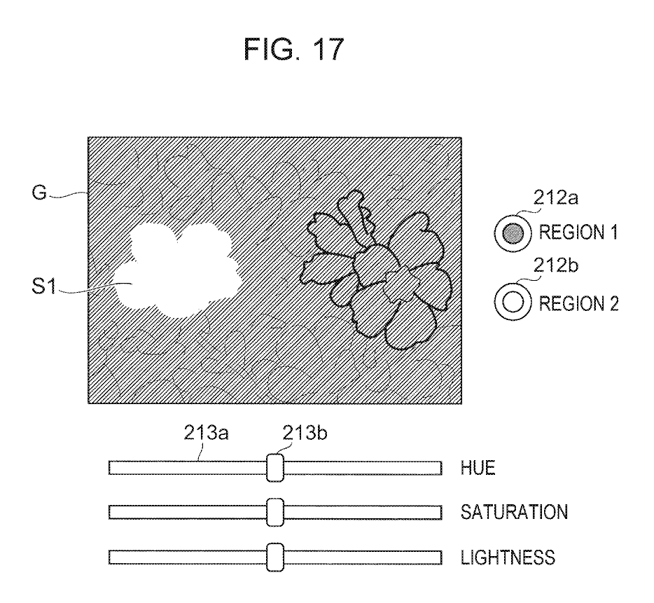

FIG. 17 illustrates an example of a screen displayed on the display screen 21 of the display apparatus 20 when image processing is performed.

In this example, the adjustment of hue, saturation, and lightness is performed on the designated region S1 or the outside region S2 that has been selected. The image G in a state where the designated region S1 or the outside region S2 is selected is displayed on the upper left side of the display screen 21, and the radio buttons 212a and 212b to be used for selecting either of “region 1” and “region 2” are displayed on the upper right side of the display screen 21. Here, the radio button 212a is selected and accordingly the designated region S1, which is an image region of a flower portion, is selected. As in the case illustrated in FIGS. 16A and 16B, operating the radio button 212a or 212b enables switching between the designated region S1 and the outside region S2.

Slide bars 213a and sliders 213b for adjusting “hue”, “saturation”, and “lightness” are displayed on the lower side of the display screen 21. Each slider 213b may be slid by being moved to the right or left on the slide bar 213a in the figure by operating the input apparatus 30. The slider 213b is located at the center of the slide bar 213a in an initial state, and represents a before-adjustment state of “hue”, “saturation”, or “lightness” at this position.

When the user slides the slider 213b of any of “hue”, “saturation”, and “lightness” to the right or left on the slide bar 213a in the figure by using the input apparatus 30, image processing is performed on the designated region S1 or the outside region S2 that has been selected, and the image G displayed on the display screen 21 is changed accordingly. In this case, when the user slides the slider 213b to the right in the figure, image processing for increasing the corresponding one of “hue”, “saturation”, and “lightness” is performed. When the user slides the slider 213b to the left in the figure, image processing for decreasing the corresponding one of “hue”, “saturation”, and “lightness” is performed.

Referring back to FIG. 2, the image information output unit 18 outputs image information that has been subjected to the foregoing image processing. The image information that has been subjected to the image processing is transmitted to the display apparatus 20. Accordingly, an image is displayed on the display apparatus 20 on the basis of the image information.

### Second Exemplary Embodiment

Next, the image processing apparatus 10 according to a second exemplary embodiment will be described.

In the first exemplary embodiment, there is one designated region. In the second exemplary embodiment, there are plural designated regions.

In the second exemplary embodiment, the user instruction receiving unit 12 receives, as user instruction information, an instruction to designate plural regions. In the second exemplary embodiment, the user instruction receiving unit 12 obtains, as user instruction information, position information about plural foreground cover regions input by the user and including plural designated regions.

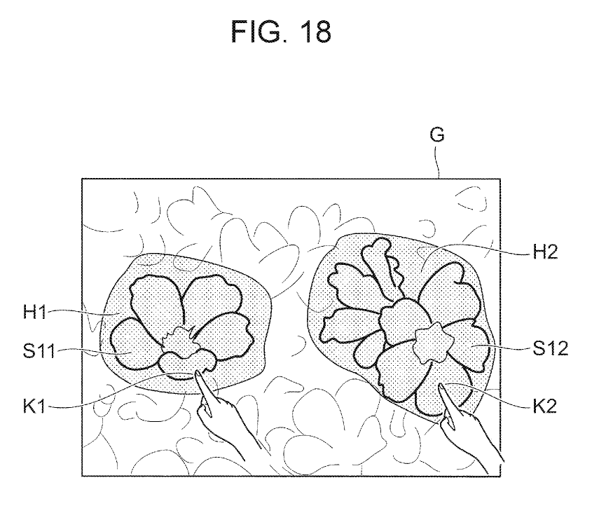

FIG. 18 is a diagram illustrating a case where the user inputs plural foreground cover regions to the image G.

Here, it is assumed that the user designates a flower on the left side and a flower on the right side having different shapes and colors in the image G, as designated regions. At this time, the user creates a trail K1 and a trail K2 respectively for the portions around the left flower portion illustrated as a designated region S11 and the right flower portion illustrated as a designated region S12 on the image G. In this way, the user inputs a foreground cover region H1 and a foreground cover region H2 respectively including the designated region S11 and the designated region S12.

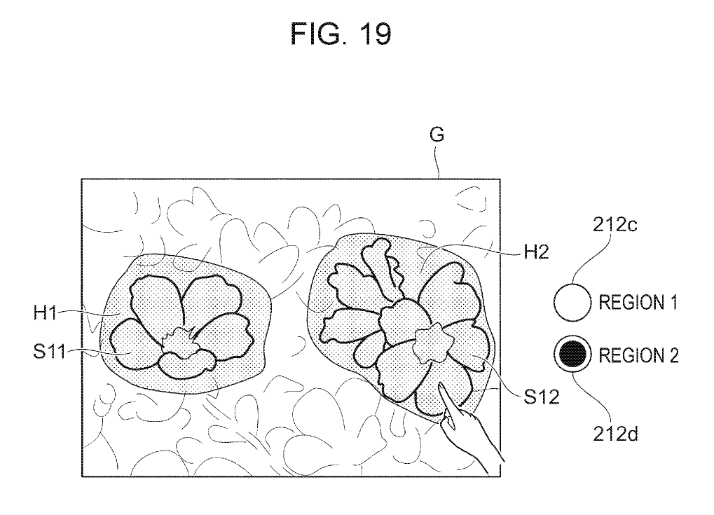

Either of the foreground cover region H1 and the foreground cover region H2 may be input first. Note that, if the foreground cover region H1 is regarded as “region 1” and the foreground cover region H2 is regarded as “region 2” and if radio buttons 212c an 212d are provided to enable switching between both the regions as illustrated in FIG. 19, user confusion may be avoided. In the example illustrated in FIG. 19, the user is inputting the foreground cover region H2, and the radio button 212d for “region 2” is selected.

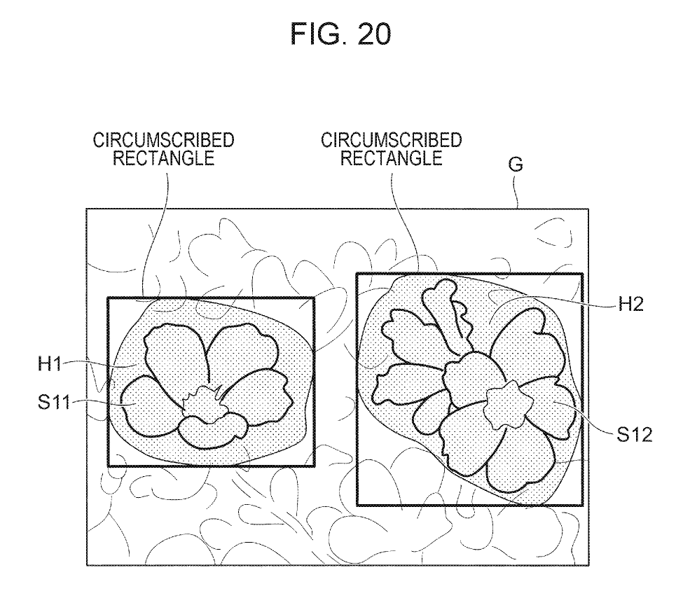

If the second representative position setting unit 14 acquires circumscribed rectangles for the foreground cover regions H, plural circumscribed rectangles are acquired as illustrated in FIG. 20.

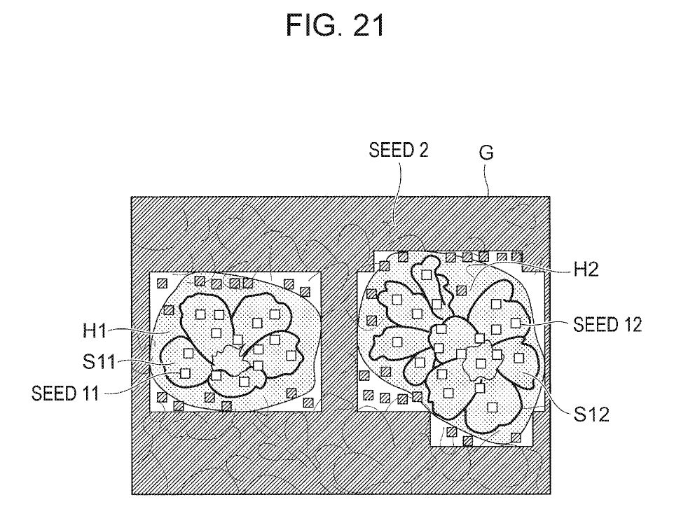

FIG. 21 illustrates an example in which the first representative position setting unit 13 and the second representative position setting unit 14 set seeds in the above-described case. Here, seed 11 is a seed for the designated region S11, whereas seed 12 is a seed for the designated region S12. Seed 2 is a seed for the outside region S2.

When designated regions have a complicated shape, the circumscribed rectangles for the regions may overlap each other.

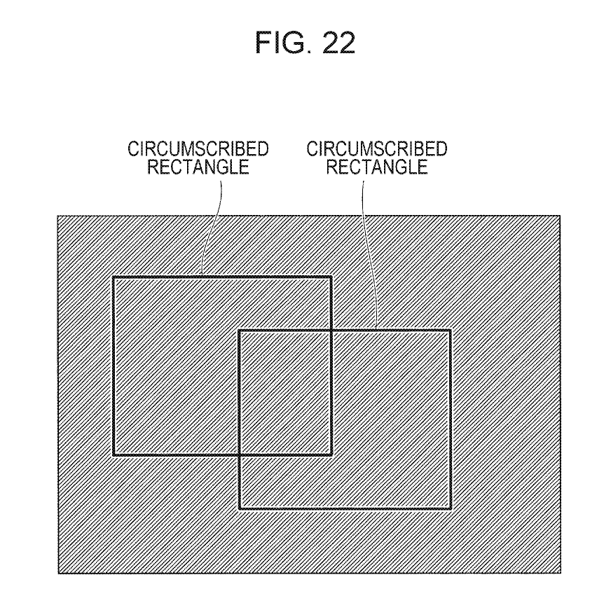

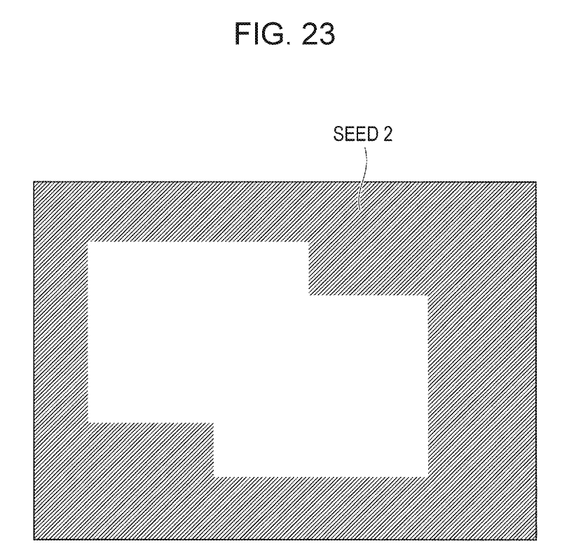

FIG. 22 illustrates a case where two circumscribed rectangles overlap each other. Also in this case, the region outside the two circumscribed rectangles may be set as seed 2 as illustrated in FIG. 23.

The region detecting unit 15 cuts out the designated regions S11 and S12. In this case, it is impossible to use the GraphCut method illustrated in FIG. 14 because the designated regions S11 and S12 are not cut out by being regarded as one foreground region. Thus, the region detecting unit 15 cuts out the designated regions S11 and S12 as two different foreground regions by using the region growing method that enables plural regions to be cut out.

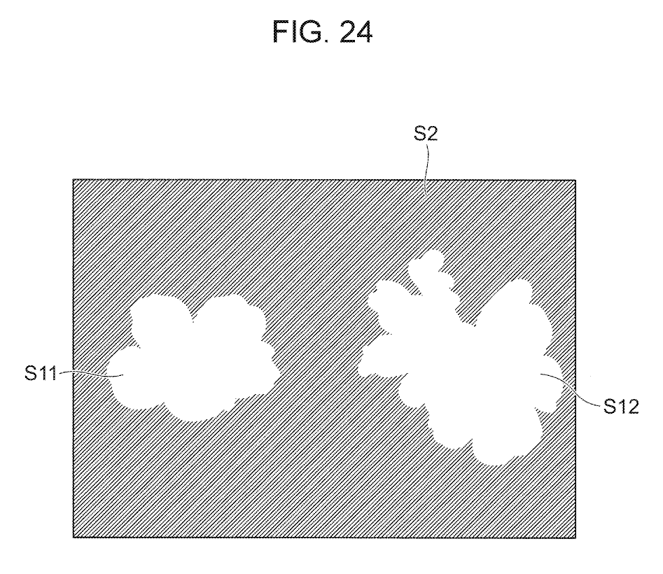

FIG. 24 illustrates a state where the designated regions S11 and S12 and the outside region S2 have been cut out from the image G illustrated in FIG. 18 by using the region growing method.

### Description of Region Detecting Unit

Next, a detailed description will be given of the method for cutting out the designated region S1 by the region detecting unit 15 by using the region growing method.

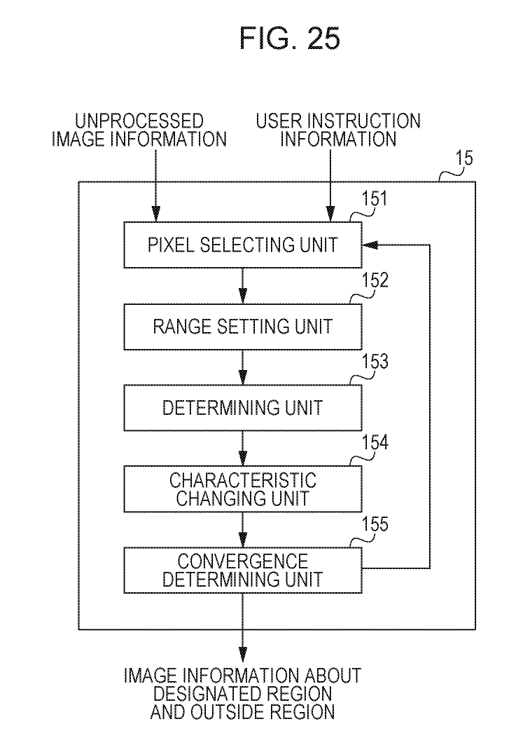

FIG. 25 is a block diagram illustrating an example functional configuration of the region detecting unit 15 according to this exemplary embodiment.

As illustrated in FIG. 25, the region detecting unit 15 according to this exemplary embodiment includes a pixel selecting unit 151, a range setting unit 152, a determining unit 153, a characteristic changing unit 154, and a convergence determining unit 155.

Hereinafter, first to fifth examples will be described regarding the region detecting unit 15 illustrated in FIG. 25.

### First Example (in the Case of “Aggressive-Type” and “Synchronous-Type”)

First, the region detecting unit 15 according to the first example will be described.

In the first example, the pixel selecting unit 151 selects a pixel belonging to the designated region S1 and a pixel belonging to the outside region S2, each serving as a reference pixel. Here, each of “the pixel belonging to the designated region S1 and the pixel belonging to the outside region S2” is, for example, a pixel at a representative position, that is, a pixel corresponding to the above-described seed, or a pixel newly labeled through region growing.

Here, the pixel selecting unit 151 selects one of the pixels belonging to the designated region S1 and one of the pixels belonging to the outside region S2, each serving as a reference pixel.

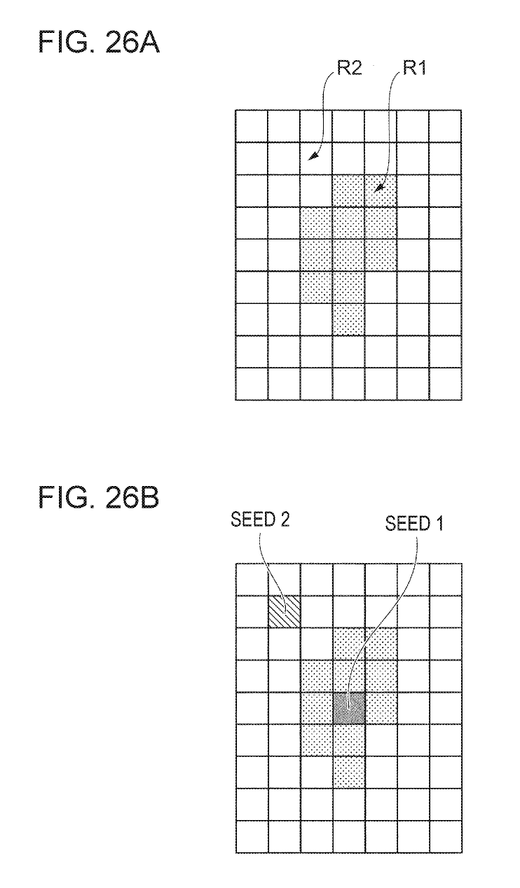

FIG. 26A illustrates an original image in which the designated region S1 and the outside region S2 are to be separated from each other. As illustrated in FIG. 26A, the original image is formed of a region including 9×7=63 pixels and includes an image region R1 and an image region R2. The pixel values of the individual pixels included in the image region R1 are close to one another, and also the pixel values of the individual pixels included in the image region R2 are close to one another. As will be described below, the image region R1 and the image region R2 are respectively regarded as the designated region S1 and the outside region S2 and are separated from each other.

To simplify the description, it is assumed that, as illustrated in FIG. 26B, there are two representative positions one of which is designated in the image region R1 and the other of which is designated in the image region R2, and each representative position is formed of one pixel. The pixel selecting unit 151 selects the one pixel as a reference pixel. In FIG. 26B, the reference pixels are represented by seed 1 and seed 2.

Although the details will be described below, seed 1 and seed 2 are labeled and have intensity. Here, label 1 and label 2 are attached to seed 1 and seed 2, respectively, and an initial value of 1 is set as intensity to both seeds.

The range setting unit 152 sets, to a reference pixel, a specific range including the reference pixel and neighboring pixels thereof. The specific range is referred as a first range. Here, the specific range is a certain specific range including a reference pixel and at least one of eight pixels adjacent to the reference pixel.

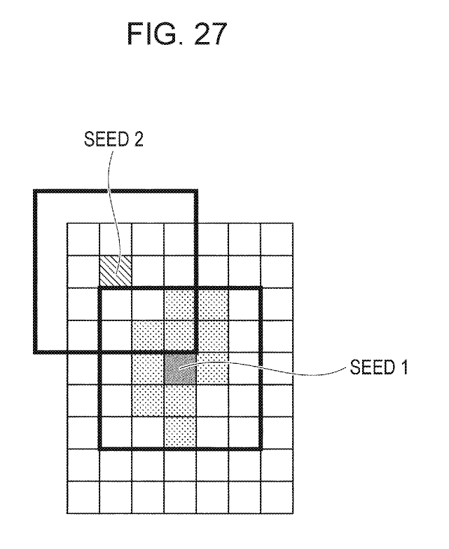

FIG. 27 is a diagram describing first ranges.

As illustrated in FIG. 27, seed 1 and seed 2, each serving as a reference pixel, are selected in the image region R1 and the image region R2, respectively. The ranges, each formed of 5×5 pixels, including seed 1 and seed 2 at the center are regarded as first ranges. In FIG. 27, each of the first ranges is illustrated as a region inside a bold-line frame.

Although the details will be described below, in this exemplary embodiment, the first ranges may be variable and may be reduced as the process proceeds.

The determining unit 153 determines which of the designated region S1 and the outside region S2 is the region to which a target pixel in a first range (first target pixel) belongs. Specifically, the determining unit 153 determines, for each of the pixels included in the first range, which of the designated region S1 and the outside region S2 including a reference pixel is the region to which the pixel belongs.

The determining unit 153 regards each of the 24 pixels other than seed 1 or seed 2 among the 25 pixels included in the first range as a target pixel (first target pixel) for which it is determined whether or not the pixel belongs to the designated region S1 or the outside region S2. Accordingly, the determining unit 153 determines whether or not these target pixels are included in the designated region S1 including seed 1 or/and whether or not these target pixels are included in the outside region S2 including seed 2.

In this case, the closeness between pixel values may be used as a determination criterion.

Specifically, numbers are assigned to the 24 pixels included in the first range for convenience. When the i-th (i is an integer of any one of 1 to 24) target pixel is represented by Pᵢ, if the color data of this pixel is RGB data, the color data may be represented by Pᵢ=(Rᵢ, Gᵢ, Bᵢ). Likewise, when the reference pixel such as seed 1 or seed 2 is represented by P₀, the color data of this pixel may be represented by P₀=(R₀, G₀, B₀). As the closeness between pixel values, the Euclidean distance dᵢ of RGB values expressed by the following Equation 2 is considered.

dᵢ=\sqrt{(Rᵢ−R₀)²+(Gᵢ−G₀)²+(Bᵢ−B₀)²} Equation 2

If the Euclidean distance dᵢ is equal to or smaller than a predetermined threshold, the determining unit 153 determines that the target pixel Pᵢ belongs to the designated region S1 or the outside region S2. That is, if the Euclidean distance dᵢ is equal to or smaller than the predetermined threshold, the pixel values of the reference pixel P₀ and the target pixel Pᵢ are estimated to be closer to each other, and thus the determining unit 153 determines that the reference pixel P₀ and the target pixel Pᵢ are included in the same designated region S1 or the same outside region S2.

The Euclidean distance dᵢ may be equal to or smaller than the threshold for both seeds 1 and 2. In this case, the determining unit 153 determines that the target pixel Pᵢ is included in the designated region S1 or the outside region S2 in which the Euclidean distance dᵢ is smaller.

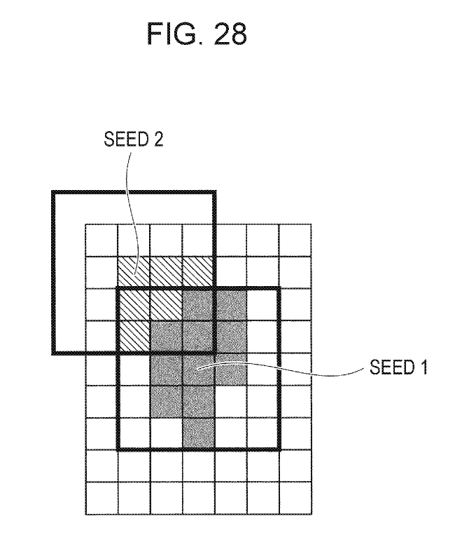

FIG. 28 illustrates a result of the determination that has been performed on the target pixels included in the first ranges illustrated in FIG. 27 on the basis of the Euclidean distance dᵢ.

Here, the pixels in the same color as seed 1 (black pixels) are determined to be pixels belonging to the designated region S1, whereas the pixels in the same pattern as seed 2 (shaded pixels) are determined to be pixels belonging to the outside region S2. The white pixels are determined to be pixels belonging to neither the designated region S1 nor the outside region S2.

With the determining unit 153 being operated in the above-described manner, a given seed may be automatically expanded. In this exemplary embodiment, for example, the determining unit 153 may perform this operation only at the first time. Alternatively, the determining unit 153 may perform this operation at the first several times. In this case, the determining unit 153 may perform determination thereafter by using “intensity” which will be described below. The determining unit 153 may perform determination by using “intensity” from the first time.

In the above-described example, the color data is RGB data. Alternatively, the color data may be color data of another color space, such as L*a*b data, YCbCr data, HSV data, or IPT data. All the color components are not necessarily used. For example, when HSV data is used as color data, only the values of H and S may be used.

If the designated region S1 and the outside region S2 are not successfully separated from each other, color data of another color space may be used. For example, instead of the Euclidean distance dᵢ using RGB values expressed by Equation 2, the Euclidean distance dᵢ^{w} using YCbCr values expressed by the following Equation 3 is considered. Equation 3 expresses the Euclidean distance dᵢ^{w} in a case where the color data of a target pixel is represented by Pᵢ=(Yᵢ, Cbᵢ, Crᵢ) and the color data of a reference pixel is represented by P₀=(y₀, Cb₀, Cr₀). The Euclidean distance dᵢ^{w} expressed by Equation 3 is a weighted Euclidean distance using weighting coefficients w_{Y}, w_{Cb}, and w_{Cr}. Use of Equation 3 is effective in a case where, for example, the difference in lightness is large but the difference in chromaticity is small between the designated region S1 and the outside region S2. That is, the weighting coefficient w_{Y} is set to be small so as to decrease the contribution of a lightness component Y to the Euclidean distance dᵢ^{w}. Accordingly, the contribution of a chromaticity component to the Euclidean distance dᵢ^{w} becomes relatively large. As a result, the accuracy in separating the designated region S1 and the outside region S2 from each other increases even if the difference in lightness is large but the difference in chromaticity is small therebetween.

dᵢ^{w}=\sqrt{w_{Y}(Yᵢ−Y₀)²+w_{Cb}(Cbᵢ−Cb₀)²+w_{Cr}(Crᵢ−Cr₀)²} Equation 3

The color data to be used is not limited to color data composed of three components. For example, an n-dimensional color space may be used and the Euclidean distance dᵢ^{w} based on n color components may be considered.

For example, Equation 4 expresses a case where color components are X₁, X₂, . . . , and Xₙ. Equation 4 expresses the Euclidean distance dᵢ^{w} in a case where the color data of a target pixel is represented by Pᵢ=(X₁ᵢ, X₂ᵢ, . . . , and Xₙᵢ) and the color data of a reference pixel is represented by P₀=(X₁₀, X₂₀, . . . , and Xₙ₀). The Euclidean distance dᵢ^{w} expressed by Equation 4 is also a weighted Euclidean distance using weighting coefficients w_{X1}, w_{X2}, . . . and w_{Xn}. In this case, the accuracy in separation is increased by making the weighting coefficient of the color component representing the characteristic of the designated region S1 or the outside region S2 among the n color components relatively larger than the other weighting coefficients.

$${d}_{i}^{w} = \sqrt{{{w}_{X 1} ( {X}_{1 i} - {X}_{1 o} )}^{2} + {{w}_{X 2} ( {X}_{2 i} - {X}_{2 o} )}^{2} + … + {{w}_{Xn} ( {X}_{ni} - {X}_{no} )}^{2}} \qquad Equation 4$$

The characteristic changing unit 154 changes the characteristic given to a target pixel in a first range (a first target pixel).

Here, the “characteristic” means the label and intensity given to the pixel.

The “label” indicates which of the designated region S1 and the outside region S2 is the region to which the pixel belongs, as described above. “Label 1” is given to the pixel belonging to the designated region S1, and “label 2” is given to the pixel belonging to the outside region S2. Here, the label of seed 1 is label 1 and the label of seed 2 is label 2. Thus, if a pixel is determined to be a pixel belonging to the designated region S1 (a black pixel in FIG. 28) by the determining unit 153, label 1 is attached to the pixel. If a pixel is determined to be a pixel belonging to the outside region S2 (a shaded pixel in FIG. 28) by the determining unit 153, label 2 is attached to the pixel.

The “intensity” is intensity of belongingness to the designated region S1 or the outside region S2 corresponding to a label, and represents the possibility that a pixel may belong to the designated region S1 or the outside region S2 corresponding to a label. The possibility that the pixel may belong to the designated region S1 or the outside region S2 corresponding to a label becomes higher as the intensity increases. The possibility that the pixel may belong to the designated region S1 or the outside region S2 corresponding to a label becomes lower as the intensity decreases. The intensity is determined in the following manner.

The intensity of a pixel included in a representative position designated first by the user is 1, which is an initial value. That is, the pixel of seed 1 or seed 2 before the region is grown has an intensity of 1. The intensity of a pixel that has not been labeled is 0.

Next, an influence of a pixel given intensity on neighboring pixels will be discussed.

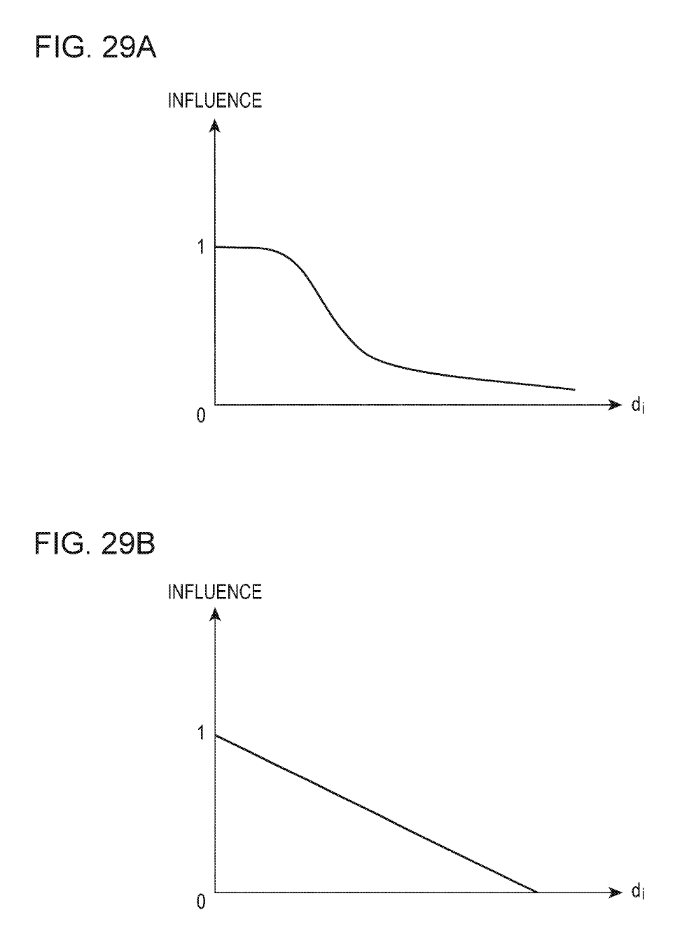

FIGS. 29A and 29B are graphs illustrating a method for determining the influence. In FIGS. 29A and 29B, the horizontal axis represents Euclidean distance dᵢ and the vertical axis represents influence.

The Euclidean distance dᵢ is a Euclidean distance dᵢ of pixel values determined between a pixel given intensity and a neighboring pixel. For example, as illustrated in FIG. 29A, a nonlinear monotonically decreasing function is defined, and a value determined in accordance with the monotonically decreasing function is regarded as influence with respect to the Euclidean distance dᵢ.

That is, the influence increases as the Euclidean distance dᵢ decreases, and the influence decreases as the Euclidean distance dᵢ increases.

The monotonically decreasing function is not limited to one in the shape illustrated in FIG. 29A, and any monotonically decreasing function may be used. For example, the linear monotonically decreasing function illustrated in FIG. 29B may be used. Alternatively, a piecewise-linear monotonically decreasing function, which is linear in a specific range of the Euclidean distance dᵢ and which is nonlinear in the other range, may be used.

The intensity of a pixel determined to belong to the designated region S1 or the outside region S2 is calculated by multiplying the intensity of the reference pixel by the influence of the reference pixel. For example, in a case where the intensity of the reference pixel is 1 and the influence of the reference pixel on an adjacent target pixel to the left thereof is 0.9, the intensity given to the target pixel when the target pixel is determined to belong to the designated region S1 or the outside region S2 is 1×0.9=0.9. For example, in a case where the intensity of the reference pixel is 1 and the influence of the reference pixel on a target pixel that is two pixels to the left thereof is 0.8, the intensity given to the target pixel when the target pixel is determined to belong to the designated region S1 or the outside region S2 is 1×0.8=0.8.

With use of the foregoing calculation method, the determining unit 153 may perform determination on the basis of the intensity given to a target pixel in a first range (a first target pixel). If the target pixel does not have a label, the determining unit 153 determines that the target pixel belongs to the designated region S1 or the outside region S2 to which the reference pixel belongs. If the target pixel already has a label related to either of the designated region S1 and the outside region S2, the determining unit 153 determines that the target pixel belongs to the region of larger intensity. In the former case, the same label as that of the reference pixel is attached. In the latter case, a label with a larger intensity in the characteristic is attached. In this method, a label attached to a pixel may be changed to another label.

For example, it is assumed that a target pixel (first target pixel) is attached with a certain label. If a reference pixel attached with another label has an intensity uᵢ and an influence wᵢⱼ, the intensity uⱼ exerted on the target pixel (first target pixel) is represented by uⱼ=Wᵢⱼuᵢ. The current intensity of the target pixel (first target pixel) is compared with the intensity uⱼ. If the intensity uⱼ is larger, the label of the target pixel is changed to another label. If the intensity uⱼ is equal to or smaller than the current intensity of the target pixel, the label of the target pixel is not changed and is maintained.

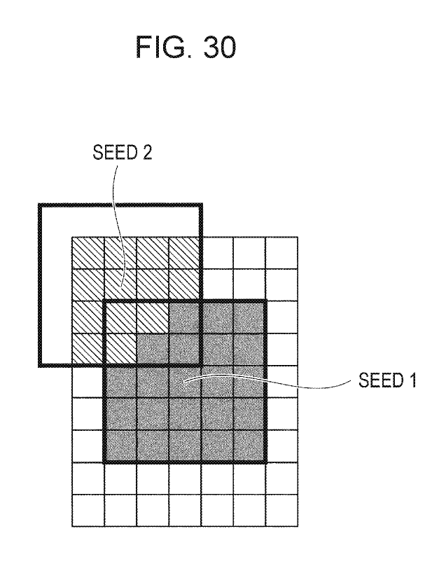

FIG. 30 illustrates a result of determination that has been made on the target pixels in the first ranges illustrated in FIG. 27 by using the method based on intensity.

In FIG. 27, the first ranges for seed 1 and seed 2 partially overlap each other. In a portion where the first ranges do not overlap each other, that is, in a portion where seed 1 and seed 2 do not compete with each other, the same label as seed 1 or seed 2 as a reference pixel is attached to all the pixels that are not labeled. On the other hand, in a portion where the first ranges overlap each other, that is, in a portion where seed 1 and seed 2 compete with each other, a label of larger intensity is attached. As a result, labeling is performed in the manner illustrated in FIG. 30.

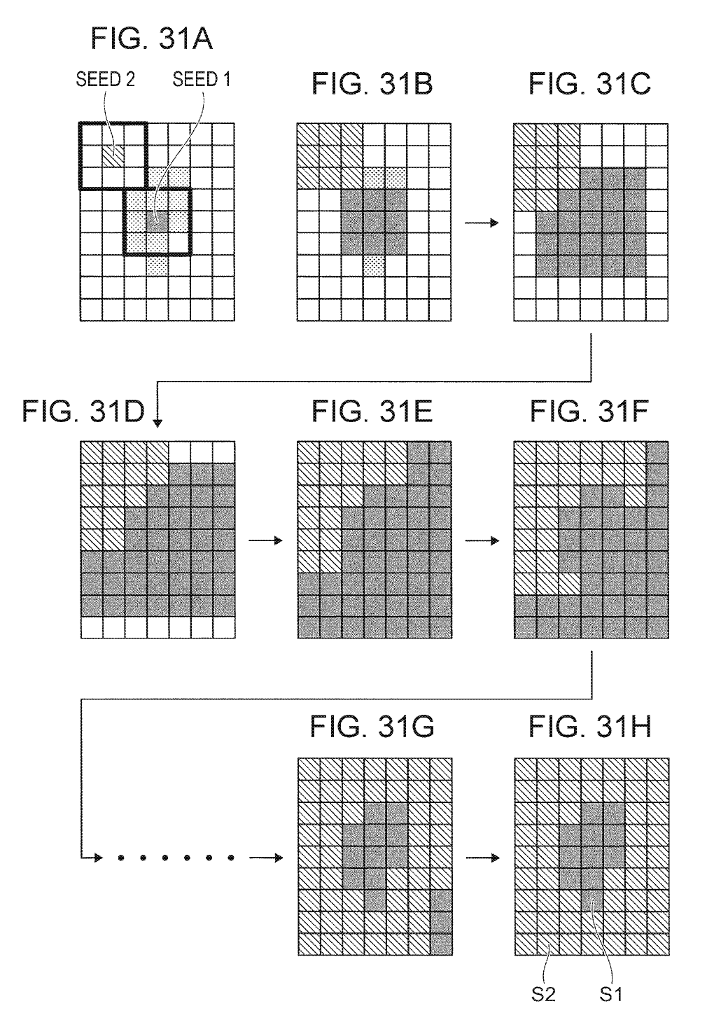

FIGS. 31A to 31H are diagrams illustrating an example of a process of sequentially labeling the pixels by using the region growing method based on intensity.

FIG. 31A illustrates the first ranges that are set in this case. In an image region R1 and an image region R2, seed 1 and seed 2, each serving as a reference pixel, are selected respectively. Furthermore, the region formed of 3×3 pixels and including seed 1 at the center and the region formed of 3×3 pixels and including seed 2 at the center are set as first ranges. In FIG. 31A, the first ranges are illustrated as regions inside bold-line frames.

FIG. 31B illustrates a result of determination performed on the target pixels in the individual first ranges of seed 1 and seed 2. In this case, the first ranges of seed 1 and seed 2 do not overlap each other, and thus all the target pixels in the first ranges are attached with the same label as that of seed 1 or seed 2 as a reference pixel.

FIG. 31C illustrates a result of further region growing and updating. In this case, the same label as that of seed 1 or seed 2 as a reference pixel is attached to the pixels in the portion where the first ranges of seed 1 and seed 2 do not overlap each other, as in FIG. 30. In the portion where the first ranges of seed 1 and seed 2 overlap each other, a label of larger intensity is attached.

Even if a label has already been attached to a target pixel, the current intensity of the target pixel is compared with the intensity exerted on the target pixel by the reference pixel, and a label of larger intensity is attached to the target pixel. The intensity of the target pixel is changed to the larger intensity. That is, in this case, the label and intensity of the target pixel are changed.

After that, each target pixel that has been labeled is selected as a new reference pixel, and the region is sequentially updated as illustrated in FIGS. 31D to 31H. Eventually, the designated region S1 and the outside region S2 are separated from each other as illustrated in FIG. 31H.

After a target pixel has been determined to belong to the designated region S1 or the outside region S2 in this way, the label and intensity of the target pixel are changed by the characteristic changing unit 154.

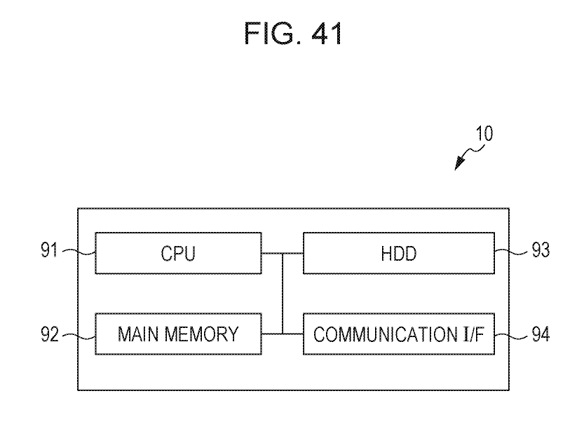

Information representing the labels, intensities, and influences is stored in a main memory 92 which will be described below (see FIG. 41) as information about the individual pixels. The information is read from the main memory 92 as necessary. If the label, intensity, or influence is changed, the information is rewritten. Accordingly, the processing speed of the region detecting unit 15 increases.

The above-described process by the pixel selecting unit 151, the range setting unit 152, the determining unit 153, and the character changing unit 154 is repeatedly performed until convergence. That is, as described above with reference to FIG. 28, a pixel that has newly been determined to belong to the designated region S1 or the outside region S2 is newly selected as a reference pixel. The specific range around the newly selected reference pixel is set as a first range, and it is determined, for each of the target pixels in the first range that has been set, which of the designated region S1 and the outside region S2 is the region to which the target pixel belongs. As a result of repeating this process and updating the pixels, the region where the characteristic is changed (labeling is performed) is gradually grown, and accordingly the designated region may be cut out. This process may also be referred to as a process of performing determination plural times while selecting a reference pixel and changing the setting of a first range and thereby detecting the designated region. According to this method (the region growing method), a certain label that has been attached to a pixel may be changed to another label.

The convergence determining unit 155 determines whether or not the foregoing series of processes have converged.

For example, the convergence determining unit 155 determines that the series of processes have converged when there are no more pixels for which the label is to be changed. Alternatively, a maximum number of times of updating may be predetermined, and the convergence determining unit 155 may determine that the series of processes have converged when the number of times of updating reaches the maximum number.

In the above-described region growing method according to the first example, the target pixels to be determined to belong to the designated region S1 or the outside region S2 are pixels that belong to a first range and that are not seed 1 or seed 2 serving as a reference pixel. The pixel values of these target pixels are compared with the pixel value of the reference pixel, and thereby it is determined which of the designated region S1 and the outside region S2 is the region to which the target pixels belong. That is, this is a so-called “aggressive-type” method in which the target pixels are changed as a result of being influenced by the reference pixel.

Also, in this region growing method, the labels and intensities of the entire image immediately before the region growing are stored. Then the determining unit 153 determines, for each of the target pixels in the first ranges that are set in accordance with reference pixels selected from the designated region S1 and the outside region S2, which of the designated region S1 and the outside region S2 is the region to which the target pixel belongs, and thereby region growing is performed. After the determination is made, the characteristic changing unit 154 changes the labels and intensities that have been stored. The changed labels and intensities are stored as the labels and intensities of the entire image immediately before the next region growing, and region growing is performed again. That is, in this case, the labels and intensities of the entire image are simultaneously changed. This is a so-called “synchronous-type” region growing method.

Furthermore, in this region growing method, a first range may be fixed or changed. In the case of changing the first range, the range may be changed so as to be reduced in accordance with the number of times of updating. Specifically, for example, the first range is first set to be large and is reduced when the number of times of updating reaches a designated number of times. Plural designated numbers of times may be set, and the first range may be reduced step by step. That is, the first range is set to be large in an initial stage so as to increase the processing speed. After updating progresses to some extent, the first range is reduced to further increase the accuracy in separating the designated region S1 and the outside region S2 from each other. That is, both the increase in the processing speed and the accuracy in cutting out the designated region S1 are achieved. In other words, the first range may be set so as to be reduced as determination is repeated.

### Second Example (in the Case of “Aggressive-Type” and “Asynchronous-Type”)

Next, the region detecting unit 15 according to the second example will be described.

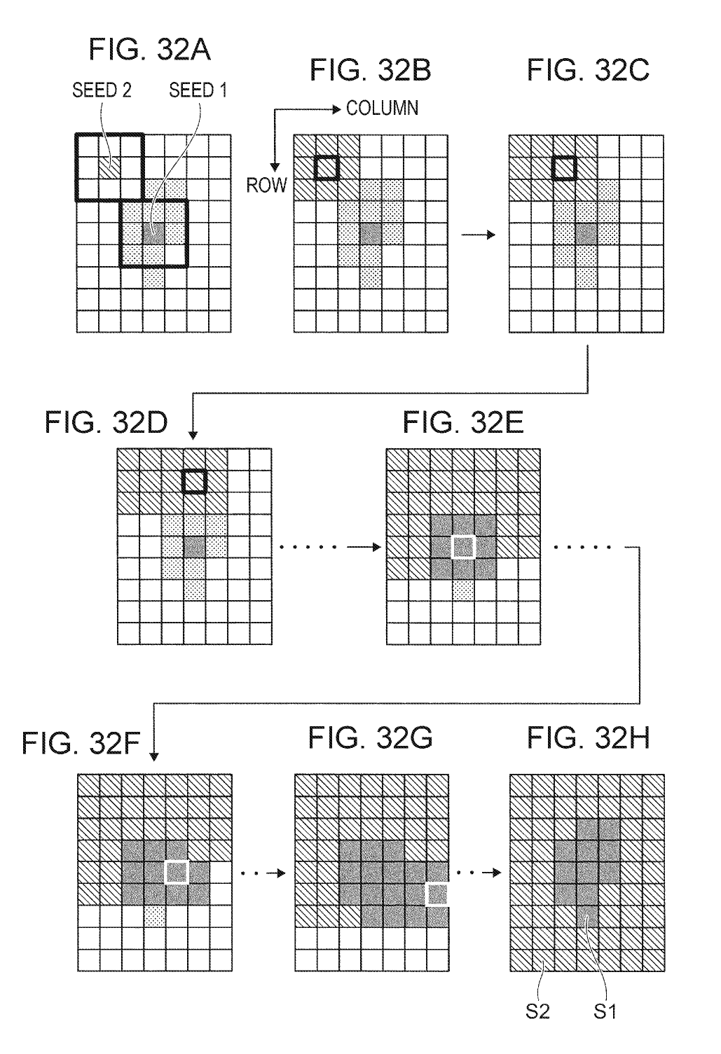

FIGS. 32A to 32H are diagrams illustrating an example of a process of sequentially labelling the pixels by using the region growing method according to the second example.

FIG. 32A illustrates, like FIG. 31A, the first ranges that are set in this case.

In the second example, the determining unit 153 regards seed 2, which is set at the position in the second row and the second column, as a starting point as illustrated in FIG. 32B, and determines which of the designated region S1 and the outside region S2 is the region to which a target pixel in the first range belongs. Subsequently, while shifting the reference pixel to the right by one pixel as illustrated in FIGS. 32C and 32D, the determining unit 153 determines which of the designated region S1 and the outside region S2 is the region to which a target pixel in the first range belongs. The determination may be performed by, for example, using the closeness between pixel values by using Equations 2 to 4 as described above. Alternatively, the determination may be performed by using intensity, as in the case illustrated in FIGS. 31A to 31H.

After the determination has been performed on the target pixel at the right end in the figure, the reference pixel is shifted to the third row, and the determining unit 153 determines which of the designated region S1 and the outside region S2 is the region to which a target pixel belongs, while shifting the reference pixel by one pixel to the right. After the determination has been performed on the target pixel at the right end in the figure, the reference pixel is shifted to the next row. This operation is repeated as illustrated in FIGS. 32E to 32G until the reference pixel reaches the right end of the last row. In other words, the determining unit 153 performs determination while shifting the reference pixel by one pixel in a scanning manner.

After the reference pixel reaches the right end of the last row and the reference pixel does not shift any more, the reference pixel is shifted in the reverse direction, and the same process is performed until the reference pixel reaches the left end of the first row. Accordingly, the reference pixel makes one go-and-return movement. After that, this go-and-return movement of the reference pixel is repeated until convergence.

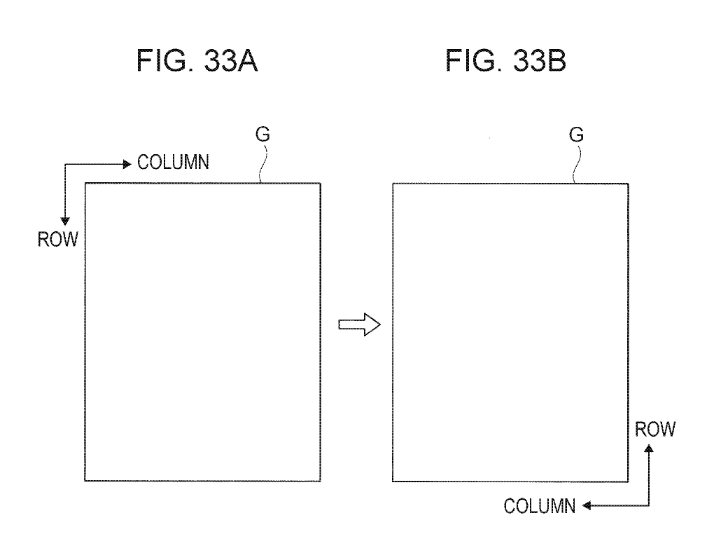

In other words, a similar process is performed by inverting the order of the row and column, as illustrated in FIGS. 33A and 33B. This process may also be referred to as a process in which the reference pixel is shifted in the reverse direction in a scanning manner after the reference pixel reaches the end position (in this case, the right end of the last row or the left end of the first row).

In this example, one starting point is set. Alternatively, plural starting points may be set and shifted. Any of the pixels in the image may be selected as a starting point.

In a case where one starting point is set, the reference pixel may be shifted in a scanning manner from the left end of the first row after the reference pixel reaches the right end of the last row. Furthermore, the reference pixel may be randomly shifted.

Eventually, the designated region S1 and the outside region S2 are separated from each other as illustrated in FIG. 32H.

According to this region growing method, convergence is achieved more quickly and the processing speed is higher than in the method described above with reference to FIGS. 31A to 31H. Furthermore, the reference pixel is further shifted in the reverse direction in a scanning manner after it reaches the end position, and accordingly a delay in convergence is less likely to occur and convergence is achieved more quickly.

In the second example, the operations of the elements other than the determining unit 153, that is, the pixel selecting unit 151, the range setting unit 152, the characteristic changing unit 154, and the convergence determining unit 155, are similar to those in the first example. Also, the first range may be fixed or changed. In the case of changing the first range, the first range may be changed so as to be reduced in accordance with the number of times of updating.

In this region growing method, every time the selected reference pixel is shifted by one pixel, the determining unit 153 determines, for each of the target pixels in the first range, which of the designated region S1 and the outside region S2 is the region to which the target pixel belongs, and accordingly region growing is performed. This process may also be referred to as a process in which the determining unit 153 determines, for each of the pixels included in the first range defined based on one selected reference pixel, which of the designated region S1 and the outside region S2 is the region to which the pixel belongs, and then newly selects one reference pixel to set a first range and perform determination again, thereby detecting the designated region S1 and the outside region S2. After the determination, the characteristic changing unit 154 changes the labels and intensities that have been stored. That is, in this case, the labels and intensities of the entire image are not simultaneously changed, but only the target pixels in the first range (first target pixels) that is defined every time the reference pixel is shifted by one pixel are targets to be changed. This is a so-called “asynchronous-type”region growing method. In the “synchronous-type” region growing method according to the first example, the labels and intensities of the entire image are simultaneously changed on the basis of the labels and intensities in the preceding state of the image when a reference pixel is selected. In this meaning, this region growing method is referred to as a “synchronous-type” method. In other words, the state of the labels and intensities changes relatively slowly. However, in the second example, unlike in the “synchronous-type”, only the label and intensity of a target pixel (first target pixel) as one pixel are changed every time a reference pixel is selected. In other words, the labels and intensities of the pixels other than the target pixel (first target pixel) are not changed. In this meaning, this region growing method is referred to as an “asynchronous-type” method. After that, a reference pixel is selected again and the pixels in the first range are regarded as target pixels. This process is repeated and accordingly the state of the labels and intensities is changed more quickly than in the synchronous-type.

In the first and second examples, a reference pixel is selected and it is determined, for each of the target pixels (first target pixels) in a first range defined based on the reference pixel, which of the designated region S1 and the outside region S2 is the region to which the target pixel belongs. The determination is performed plural times while sequentially selecting a reference pixel and changing the first range that is set in accordance with the reference pixel. The determination is performed by comparing pixel values or intensities, as described above. Accordingly, the labels of the target pixels in the first range (first target pixels) are changed. In this case, the reference pixel has an influence on the neighboring target pixels (first target pixels), and thus the labels of the target pixels (first target pixels) are changed. In this meaning, this region growing method is referred to as an “aggressive-type” method.

Next, a description will be given of the operation of the region detecting unit 15 according to the first and second examples.

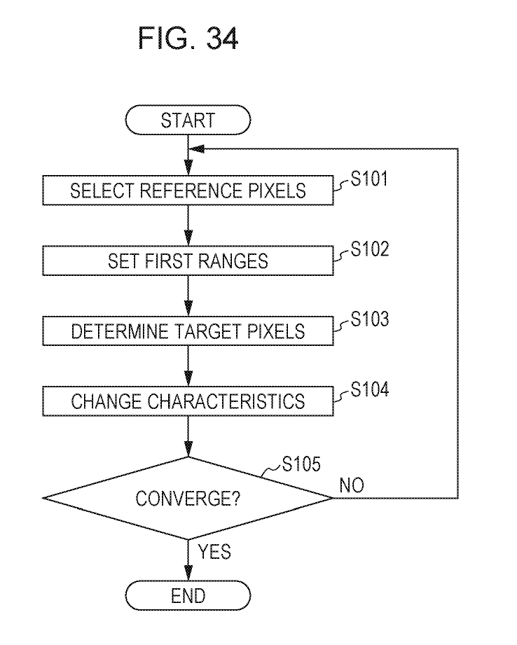

FIG. 34 is a flowchart illustrating the operation of the region detecting unit 15 according to the first and second examples.

Hereinafter, the operation of the region detecting unit 15 will be described with reference to FIGS. 25 and 34.

First, the pixel selecting unit 151 selects reference pixels respectively belonging to the designated region S1 and the outside region S2 (step S101). In the example illustrated in FIG. 26B, the pixel selecting unit 151 selects seed 1 and seed 2 as reference pixels.

Subsequently, the range setting unit 152 sets first ranges, which are ranges of target pixels (first target pixels) for which it is determined which of the designated region S1 and the outside region S2 is the region to which each pixel belongs (step S102). In the example illustrated in FIG. 27, the range setting unit 152 sets, as the first ranges, a range formed of 5×5 pixels including seed 1 at the center and a range formed of 5×5 pixels including seed 2 at the center.

Subsequently, the determining unit 153 determines, for each of the target pixels in the first ranges, which of the designated region S1 and the outside region S2 is the region to which the target pixel belongs (step S103). At this time, at a portion where a target pixel belongs to both the designated region S1 and the outside region S2, the determining unit 153 determines that the target pixel belongs to the region of larger intensity among the designated region S1 and the outside region S2. Alternatively, the determining unit 153 may perform determination on the basis of the Euclidean distance dᵢ between pixel values and grow the designated region S1 and the outside region S2.

Furthermore, the characteristic changing unit 154 changes the characteristics of the target pixels that have been determined by the determining unit 153 to belong to the designated region S1 or the outside region S2 (step S104). Specifically, the characteristic changing unit 154 labels these target pixels and gives intensity to these target pixels.

Subsequently, the convergence determining unit 155 determines whether or not the series of processes have converged (step S105). The convergence determining unit 155 may determine that the series of processes have converged when there are no more pixels whose labels are to be changed or when the number of times of updating reaches a predetermined maximum number.

If the convergence determining unit 155 determines that the series of processes have converged (YES in step S105), the process of cutting out the designated region S1 ends.

On the other hand, if the convergence determining unit 155 determines that the series of processes have not converged (NO in step S105), the process returns to step S101. In this case, other reference pixels are selected by the pixel selecting unit 151.

### Third Example (in the Case of “Passive-Type” and “Synchronous-Type)

Next, the region detecting unit 15 according to the third example will be described.

In the third example, the pixel selecting unit 151 selects one target pixel as a target for which it is determined which of the designated region S1 and the outside region S2 is the region to which the target pixel belongs. The range setting unit 152 changes a second range, which is a range set for the selected target pixel (second target pixel) and including a reference pixel that is used to determine which of the designated region S1 and the outside region S2 is the region to which the target pixel belongs.

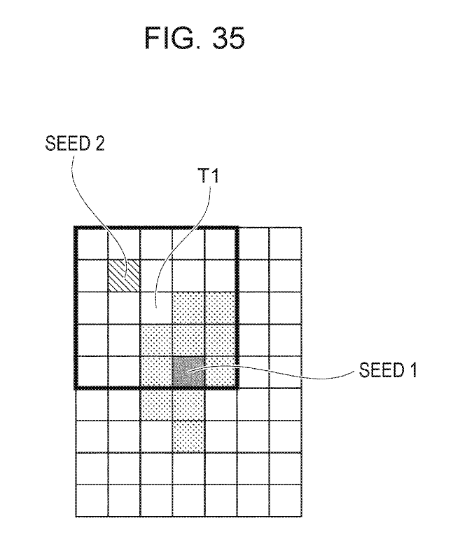

FIG. 35 is a diagram illustrating a target pixel selected by the pixel selecting unit 151 and a second range set by the range setting unit 152.

In FIG. 35, seed 1 and seed 2 are set as reference pixels as in the case illustrated in FIG. 26B with respect to the original image illustrated in FIG. 26A. Here, one pixel denoted by T1 is selected as a target pixel (second target pixel). Furthermore, the range formed of 5×5 pixels including the target pixel T1 at the center is set as the second range. In FIG. 35, the second range is illustrated as a region inside a bold-line frame.

The determining unit 153 determines which of the designated region S1 and the outside region S2 is the region to which the target pixel T1 belongs. The determining unit 153 determines which of the designated region S1 including seed 1 and the outside region S2 including seed 2 is the region to which the target pixel T1 belongs.

At this time, for example, the determining unit 153 determines which of the designated region S1 and the outside region S2 is the region to which the target pixel T1 belongs by determining which of the pixel value of seed 1 and the pixel value of seed 2 serving as reference pixels included in the second range is closer to the pixel value of the target pixel T1. That is, the determining unit 153 performs determination on the basis of the closeness between pixel values.

Alternatively, the determination may be performed on the basis of intensity. In this case, which of the designated region S1 and the outside region S2 is the region to which the target pixel T1 (second target pixel) belongs is determined on the basis of the intensities of the reference pixels included in the second range.

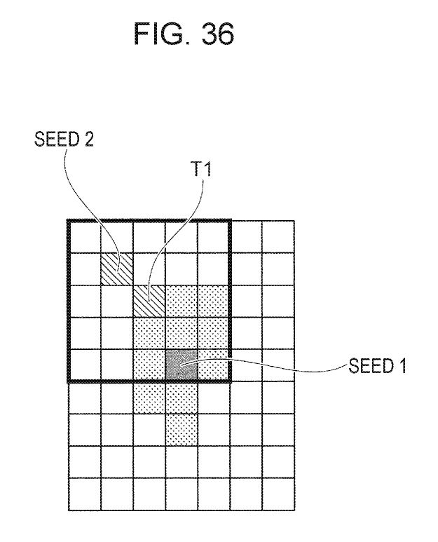

FIG. 36 is a diagram illustrating a result of determination according to this example.

FIG. 36 illustrates a case where the pixel value of the target pixel T1 is closer to the pixel value of seed 2 than the pixel value of seed 1, and as a result it is determined that the target pixel T1 belongs to the outside region S2.

The operations of the characteristic changing unit 154 and the convergence determining unit 155 are similar to those in the first example.

Also in this example, the process by the pixel selecting unit 151, the range setting unit 152, the determining unit 153, and the character changing unit 154 is repeated until convergence. With the process being repeated and update being performed, the region in which the characteristics are changed by labeling is sequentially grown and accordingly the designated region S1 may be separated from the outside region S2. The second range is variable and may be sequentially reduced in accordance with the number of times of updating.

Specifically, the second range is first set to be large and is reduced when the number of times of updating reaches a designated number. Plural designated numbers may be set and the second range may be reduced step by step. That is, the second range is set to be large in an initial state so as to increase the possibility that the reference pixels are included therein and to make the determination more efficient. After updating progresses to some extent, the second range is reduced so as to increase the accuracy in separating the designated region S1 and the outside region S2 from each other.

In the region growing method according to the third example, attention is focused on the target pixel T1, and the pixel value of the target pixel T1 is compared with the pixel values of the reference pixels (seed 1, seed 2) in the second range so as to determine which of the designated region S1 and the outside region S2 is the region to which the target pixel T1 belongs. This is a so-called “passive-type” method in which the target pixel T1 is changed by being influenced by the reference pixels in the second range.

Also in the passive-type method, a certain label attached to a pixel may be changed to another label.

This method is similar to the region growing method according to the related art. In the region growing method according to the related art, the target pixel T1 is influenced by eight neighboring pixels that are in contact with the target pixel T1 and that are fixed. In contrast, the region growing method according to the third example is characterized in that the second range is variable. With the second range being increased, determination may be performed more efficiently as described above. If the eight neighboring pixels are fixed, the possibility that a reference pixel exists therein decreases and thus determination efficiency decreases.

Furthermore, in this region growing method, the labels and intensities of the entire image immediately before region growing are stored. Then the determining unit 153 determines which of the designated region S1 and the outside region S2 is the region to which the target pixel T1 that has been selected belongs, and region growing is performed. After the determination, the characteristic changing unit 154 changes the labels and intensities that have been stored. The changed labels and intensities are stored as the labels and intensities of the entire image immediately before the next region growing, and region growing is performed again. That is, this is a so-called “synchronous-type” region growing method.

With the second range being reduced, the accuracy in separating the designated region S1 and the outside region S2 from each other increases. Thus, the second range according to this example is changed to be reduced in accordance with the number of times of updating.

### Fourth Example (in the Case of “Passive-Type” and “Asynchronous-Type”)

The above-described case corresponds to the “synchronous-type” similar to that in the first example, but the “asynchronous-type” similar to that in the second example may be used. Hereinafter, the method of “passive-type” and also of “asynchronous-type” will be described as a fourth example.

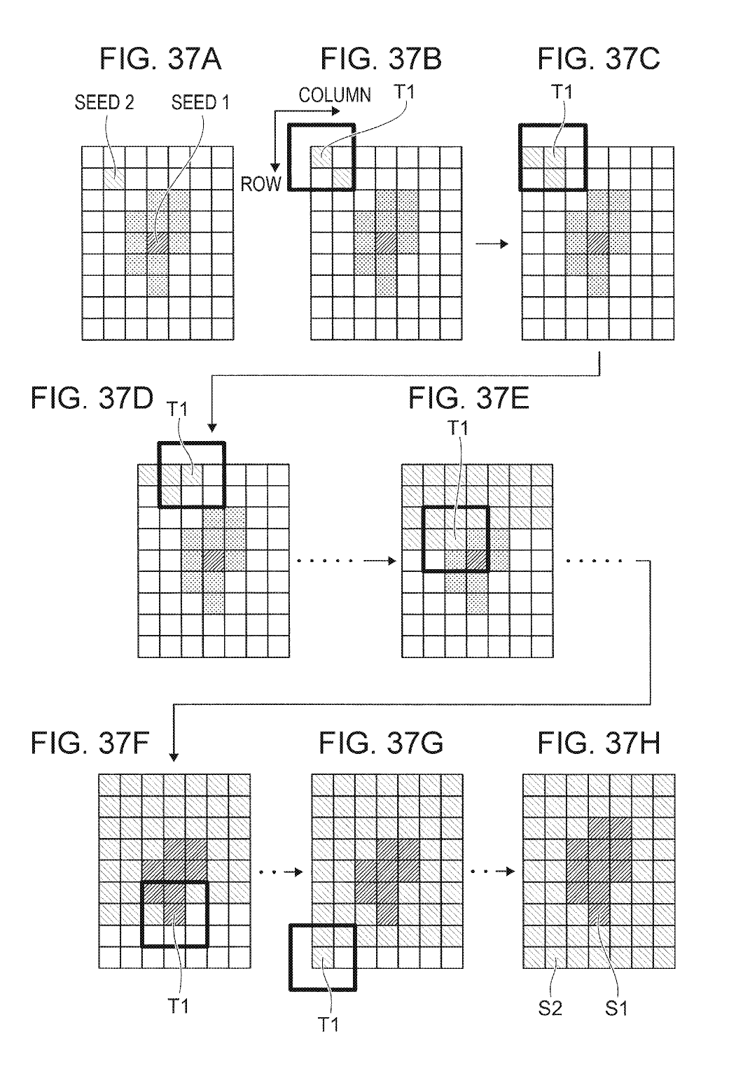

FIGS. 37A to 37H are diagrams illustrating an example of a process of sequentially labeling the pixels by using the region growing method according to the fourth example.

FIG. 37A illustrates a case where seed 1 and seed 2 as reference pixels illustrated in FIG. 26B are set to the original image illustrated in FIG. 26A. This is similar to the cases illustrated in FIGS. 31A to 31H and 32A to 32H.

FIG. 37B illustrates a second range that is set at this time. In the fourth example, the determining unit 153 regards the position in the first row and the first column as a starting point and the target pixel T1 as illustrated in FIG. 37B, and determines which of the designated region S1 and the outside region S2 is the region to which the target pixel T1 belongs. The determining unit 153 then determines which of the designated region S1 and the outside region S2 is the region to which the target pixel T1 belongs while shifting the target pixel T1 by one pixel to the right, as illustrated in FIGS. 37C and 37D. The determination is performed on the basis of intensity, as in the first to third examples.

After determining the target pixel T1 at the right end in the figure, the determining unit 153 shifts the target pixel T1 to the second row, and determines which of the designated region S1 and the outside region S2 is the region to which the target pixel T1 belongs while shifting the target pixel T1 by one pixel to the right. After determining the target pixel T1 at the right end in the figure, the determining unit 153 shifts the target pixel T1 to the next row. This operation is repeated as illustrated in FIGS. 37E to 37G until the target pixel T1 reaches the right end of the last row in the figure.

When the target pixel T1 reaches the right end of the last row and further shift of the target pixel T1 is impossible, the target pixel T1 is shifted in the reverse direction and a similar process is performed until the target pixel T1 reaches the left end of the first row. Accordingly, the target pixel T1 makes one go-and-return movement. After that, this go-and-return movement of the target pixel T1 is repeated until convergence.

In the example described here, there is one starting pint. Alternatively, plural starting points may be set as described in the third example and may be shifted. Furthermore, any pixel in the image may be selected as a starting point.

Eventually, the designated region S1 and the outside region S2 are separated from each other as illustrated in FIG. 37H.

Also in this region growing method, convergence is achieved quickly and the processing speed increases. Furthermore, the reference pixel is shifted in the reverse direction in a scanning manner after it reaches the end position, and accordingly a delay in convergence is less likely to occur and convergence is achieved more quickly.

The second range may be fixed or may be changed. In the case of changing the second range, the second range may be changed so as to be reduced in accordance with the number of times of updating.

In this region growing method, every time the selected target pixel T1 is shifted by one pixel, the determining unit 153 determines which of the designated region S1 and the outside region S2 is the region to which the target pixel T1 belongs, and accordingly region growing is performed. That is, an operation of selecting one target pixel T1 (second target pixel) in predetermined order and performing one determination on the selected target pixel T1 (second target pixel) is repeated. In other words, the determining unit 153 determines which of the designated region S1 and the outside region S2 is the region to which one target pixel T1 (second target pixel) selected as a reference pixel belongs, selects another target pixel T1 (second target pixel) to set a second range and perform determination again, and thereby detects the designated region S1 and the outside region S2. After the determination, the characteristic changing unit 154 changes the labels and intensities that have been stored. That is, in this case, only the target pixel T1 (second target pixel) becomes a target to be changed every time the target pixel T1 is shifted by one pixel. This is an “asynchronous-type” region growing method.

In the third and fourth examples, one target pixel T1 (second target pixel) is selected and it is determined whether or not the target pixel T1 is included in the designated region S1 or the outside region S2 that includes a reference pixel in the second range. The determination is performed plural times while the target pixel T1 (second target pixel) is selected and the second range that is set according to the selection is sequentially changed. The determination is performed by comparing pixel values or intensities, as described above. Accordingly, the label of the target pixel T1 (second target pixel) is changed. In this case, the target pixel T1 (second target pixel) is influenced by a neighboring reference pixel and accordingly the label of the target pixel T1 (second target pixel) is changed. In this meaning, this method is referred to as a “passive-type” method.

Next, a description will be given of the operation of the region detecting unit 15 according to the third and fourth examples.

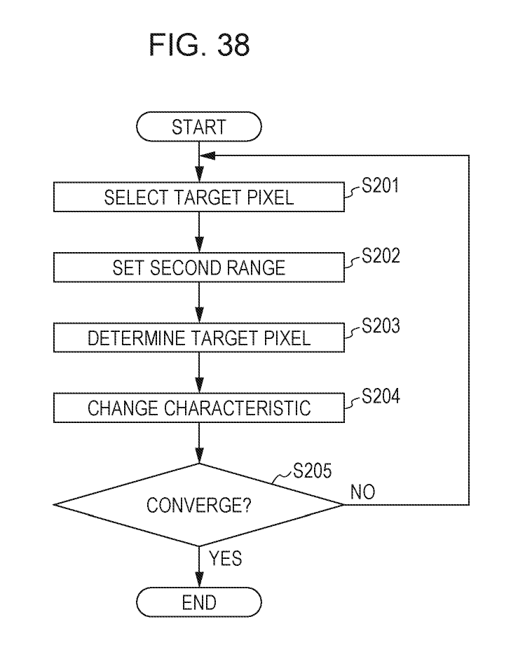

FIG. 38 is a flowchart illustrating the operation of the region detecting unit 15 according to the third and fourth examples.

Hereinafter, the operation of the region detecting unit 15 will be described with reference to FIGS. 25 and 38.

First, the pixel selecting unit 151 selects a target pixel (second target pixel) (step S201). In the example illustrated in FIG. 35, the pixel selecting unit 151 selects the target pixel T1.

Subsequently, the range setting unit 152 sets, to the target pixel T1, a second range which is a range of pixels having an influence on determination (step S202). In the example illustrated in FIG. 35, the range setting unit 152 sets, as the second range, a region formed of 5×5 pixels including the target pixel T1 at the center.

The determining unit 153 determines which of the designated region S1 and the outside region S2 is the region to which the target pixel T1 belongs (step S203). In the foregoing example, the determining unit 153 performs determination by comparing the pixel values or intensities of the target pixel T1 and seeds 1 and 2.

If the determining unit 153 determines that the target pixel T1 belongs to either of the designated region S1 and the outside region S2, the characteristic changing unit 154 changes the characteristic (step S204). Specifically, the characteristic changing unit 154 labels the target pixel T1 and gives intensity to the target pixel T1.

Subsequently, the convergence determining unit 155 determines whether the series of processes have converged (step S205). The convergence determining unit 155 may determine that the series of processes have converged if there are no more pixels for which the label is to be changed or if the number of times of updating reaches a predetermined maximum number.

If the convergence determining unit 155 determines that the series of processes have converged (YES in step S205), the process of cutting out the designated region S1 ends.

On the other hand, if the convergence determining unit 155 determines that the series of processes have not converged (NO in step S205), the process returns to step S201. In this case, the pixel selecting unit 151 selects another target pixel (second target pixel).

### Fifth Example (in the Case of Using Both “Aggressive-Type” and “Passive-Type”)

Next, the region detecting unit 15 according to the fifth example will be described.

In the fifth example, both the “aggressive-type” region growing method described in the first and second examples and the “passive-type” region growing method described in the third and fourth examples are used. That is, in the fifth example, region growing is performed while switching between the “aggressive-type” region growing method and the “passive-type” region growing method during updating.

Specifically, the range setting unit 152 selects either of the “aggressive-type” region growing method and the “passive-type” region growing method every time updating is to be performed. If the range setting unit 152 selects the “aggressive-type” region growing method, the range setting unit 152 sets a first range. The determining unit 153 determines, for each of the target pixels in the first range, which of the designated region S1 and the outside region S2 is the region to which the target pixel belongs. If the range setting unit 152 selects the “passive-type” region growing method, the range setting unit 152 sets a second range. The determining unit 153 determines which of the designated region S1 and the outside region S2 is the region to which the target pixel in the second range belongs. That is, determination is performed by switching at least once between the setting of a first range and the setting of a second range.

The switching method is not particularly limited. For example, the “aggressive-type” and the “passive-type” may be alternately used. Alternatively, the “aggressive-type” may be used the number of times corresponding to a predetermined number of times of updating and then the “passive-type” may be used until the end. Alternatively, the “passive-type” may be used the number of times corresponding to a predetermined number of times of updating and then the “aggressive-type” may be used until the end. In the case of the “aggressive-type”, either of the first and second examples may be used.

In this way, the region growing method using both the “aggressive-type” and the “passive-type” enables separation of the designated region S1 and the outside region S2 from each other.

In this example, the first and second ranges that are set may be fixed or variable. The first and second ranges may be sequentially reduced in accordance with the number of times of updating. Furthermore, either of the “synchronous-type” according to the first example and the “asynchronous-type” according to the second example may be used.

Next, the operation of the region detecting unit 15 according to the fifth example will be described.

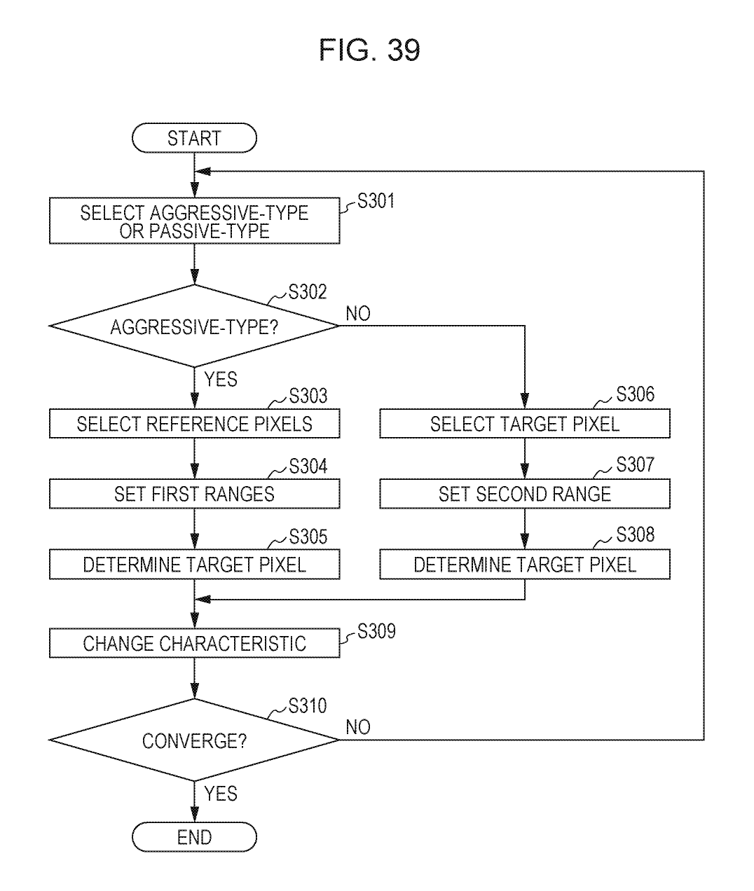

FIG. 39 is a flowchart illustrating the operation of the region detecting unit 15 according to the fifth example.

Hereinafter, the operation of the region detecting unit 15 will be described with reference to FIGS. 25 and 39.

First, the pixel selecting unit 151 selects which of the “aggressive-type” and the “passive-type” is to be used (step S301).

If the pixel selecting unit 151 selects the “aggressive-type” (YES in step S302), the pixel selecting unit 151 selects reference pixels from among the pixels belonging to the designated region S1 and the outside region S2 (step S303).

The range setting unit 152 sets, to the reference pixels, first ranges which are ranges of target pixels (first target pixels) for which it is determined which of the designated region S1 and the outside region S2 is the region to which each of the target pixels belongs (step S304).

Furthermore, the determining unit 153 determines, for each of the target pixels in the first ranges, which of the designated region S1 and the outside region S2 is the region to which the target pixel belongs (step S305).

On the other hand, if the pixel selecting unit 151 selects the “passive-type” (NO in step S302), the pixel selecting unit 151 selects the target pixel T1 (second target pixel) (step S306).

The range setting unit 152 sets, to the target pixel T1, a second range which is a range of pixels having an influence on determination (step S307).

Furthermore, the determining unit 153 determines which of the designated region S1 and the outside region S2 is the region to which the target pixel T1 (second target pixel) belongs (step S308).

Subsequently, the character changing unit 154 changes the characteristic of the target pixel T1 (second target pixel) that has been determined by the determining unit 153 to belong to either of the designated region S1 and the outside region S2 (step S309).

The convergence determining unit 155 determines whether or not the series of processes have converged (step S310).

If the convergence determining unit 155 determines that the series of processes have converged (YES in step S310), the process of cutting out the designated region S1 ends.

On the other hand, if the convergence determining unit 155 determines that the series of processes have not converged (NO in step S310), the process returns to step S301. In this case, the pixel selecting unit 151 selects another reference pixel or target pixel (second target pixel).

### Description of Operation of Image Processing Apparatus

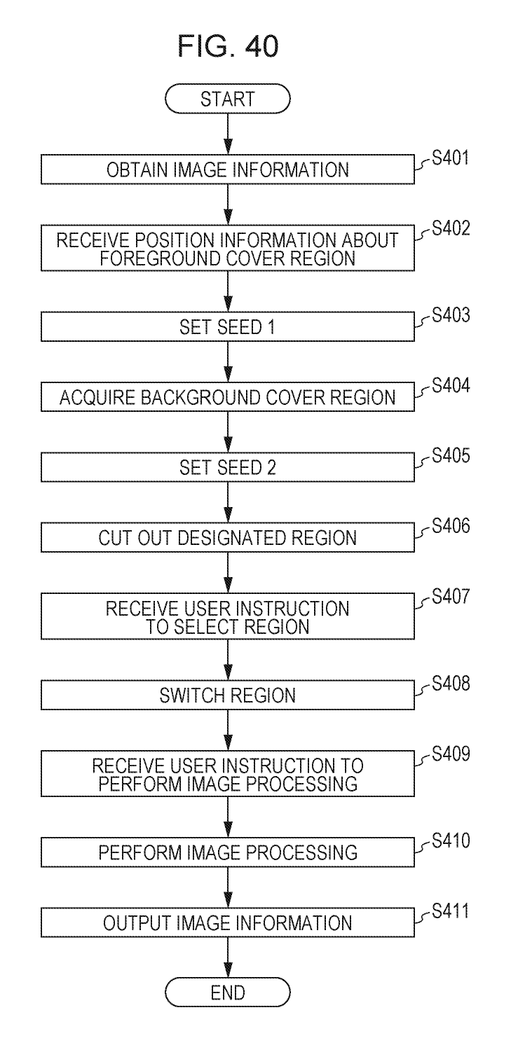

FIG. 40 is a flowchart illustrating the operation of the image processing apparatus 10.

Hereinafter, the operation of the image processing apparatus 10 will be described with reference to FIGS. 2 and 40.

First, the image information obtaining unit 11 obtains RGB data as image information about an image to be subjected to image processing (step S401). The RGB data is transmitted to the display apparatus 20, and an image to be subjected to image processing is displayed thereon.

For example, the user inputs the foreground cover region H (H1, H2) including the designated region S1 (S11, S12) by creating a trail by using the input apparatus 30 and the method described above with reference to FIGS. 3B and 18. The position information about the foreground cover region H (H1, H2) is received by the user instruction receiving unit 12 (step S402).

Subsequently, the first representative position setting unit 13 sets seed 1, which is a first representative position, on the basis of the position information about the foreground cover region H (H1, H2) by using the method described above with reference to FIGS. 5 to 8 (step S403).

Furthermore, the second representative position setting unit 14 acquires the background cover region J by using the method described above with reference to FIGS. 9A and 9B (step S404).

Also, the second representative position setting unit 14 sets seed 2, which is a second representative position, by using the method described above with reference to FIGS. 11 to 13, 21, and 23 (step S405).

Subsequently, the region detecting unit 15 performs a process of cutting out the designated region S1 (S11, S12) on the basis of seed 1 and seed 2 by using a region growing method or the like (step S406).

Subsequently, the user selects the designated region S1 (S11, S12) or the outside region S2 by using the input apparatus 30. This may be performed through, for example, the operation described above with reference to FIGS. 16A and 16B.

The user instruction to select the designated region S1 (S11, S12) or the outside region S2 is received by the user instruction receiving unit 12 (step S407).

Subsequently, the region switching unit 16 switches between the designated region S1 (S11, S12) and the outside region S2 (step S408).

The user inputs an instruction of image processing to be performed on the selected designated region S1 (S11, S12) or the outside region S2 by using the input apparatus 30. The instruction may be input by using, for example, the slider 213b described above with reference to FIG. 17.

The user instruction to perform image processing is received by the user instruction receiving unit 12 (step S409).

Subsequently, the image processing unit 17 performs image processing on the selected designated region S1 (S11, S12) or the outside region S2 in accordance with the user instruction (step S410).

Subsequently, the image information output unit 18 outputs the image information that has been subjected to image processing (step S411). The image information is RGB data, which is transmitted to the display apparatus 20. Accordingly, the image that has been subjected to image processing is displayed on the display screen 21.

The above-described process performed by the region detecting unit 15 may be regarded as an image processing method of obtaining image information about the image G, obtaining position information about the foreground cover region H input by the user and including the designated region S1 (S11, S12), which is a specific image region in the image G, acquiring a feature quantity of the designated region S1 (S11, S12) from the image information about the foreground cover region H, setting a first representative position (seed 1), which is a representative position of the designated region S1 (S11, S12), in accordance with the feature quantity of the designated region S1 (S11, S12), setting a second representative position (seed 2), which is a representative position of the outside region S2 outside the designated region S1 (S11, S12), and detecting the designated region S1 (S11, S12) by using the first representative position (seed 1) and the second representative position (seed 2).

### Example Hardware Configuration of Image Processing Apparatus

Next, the hardware configuration of the image processing apparatus 10 will be described.

FIG. 41 is a diagram illustrating the hardware configuration of the image processing apparatus 10.

The image processing apparatus 10 is, for example, a personal computer or the like, as described above. As illustrated in FIG. 41, the image processing apparatus 10 includes a central processing unit (CPU) 91 serving as an arithmetic unit, the main memory 92 serving as a memory, and a hard disk drive (HDD) 93. Here, the CPU 91 executes various programs such as an operating system (OS) and application software. The main memory 92 is a storage area that stores the various programs and data used to execute the programs. The HDD 93 is a storage area that stores input data for the various programs or output data from the various programs.

Furthermore, the image processing apparatus 10 includes a communication interface (I/F) 94 for communicating with an external apparatus.

### Description of Program

The processes performed by the image processing apparatus 10 according to the exemplary embodiment described above are prepared as programs, such as application software.

Thus, the processes performed by the image processing apparatus 10 according to the exemplary embodiment may be regarded as a program that causes a computer to execute a process including: obtaining image information about the image G, obtaining position information about the foreground cover region H input by the user and including the designated region S1 (S11, S12), which is a specific image region in the image G, acquiring a feature quantity of the designated region S1 (S11, S12) from the image information about the foreground cover region H, setting a first representative position (seed 1), which is a representative position of the designated region S1 (S11, S12), in accordance with the feature quantity of the designated region S1 (S11, S12), setting a second representative position (seed 2), which is a representative position of the outside region S2 outside the designated region S1 (S11, S12), and detecting the designated region S1 (S11, S12) by using the first representative position (seed 1) and the second representative position (seed 2).

The program implementing the exemplary embodiment may be provided by storing it in a recording medium such as a compact disc read only memory (CD-ROM), as well as through a communication unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an image information obtaining unit that obtains image information about an image;
a position information obtaining unit that obtains position information about an inclusive region input by a user and including a designated region, the designated region being a specific image region in the image;
a first representative position setting unit that acquires a feature quantity of the designated region from image information about the inclusive region and sets a first representative position, which is a representative position of the designated region, in accordance with the feature quantity of the designated region;
a second representative position setting unit that sets a second representative position, which is a representative position of an outside region, the outside region being a region outside the designated region; and
a region detecting unit that detects the designated region by using the first representative position and the second representative position.

2. The image processing apparatus according to claim 1, wherein the inclusive region is input by the user by filling-in the designated region and a region around the designated region in the image.

3. The image processing apparatus according to claim 1, wherein the first representative position setting unit acquires the feature quantity of the designated region by using a histogram representing a frequency relative to a pixel value included in the image information about the inclusive region.

4. The image processing apparatus according to claim 3, wherein the first representative position setting unit acquires the feature quantity of the designated region by comparing the frequency with a threshold set for the frequency and sets a pixel having the feature quantity of the designated region as the first representative position.

5. The image processing apparatus according to claim 1, wherein the second representative position setting unit acquires a feature quantity of the outside region from image information about a region other than the inclusive region and sets the second representative position in accordance with the feature quantity of the outside region.

6. The image processing apparatus according to claim 5, wherein the second representative position setting unit acquires the feature quantity of the outside region from image information about a region other than a circumscribed rectangle of the inclusive region.

7. An image processing method comprising:
obtaining image information about an image;
obtaining position information about an inclusive region input by a user and including a designated region, the designated region being a specific image region in the image;
acquiring a feature quantity of the designated region from image information about the inclusive region and setting a first representative position, which is a representative position of the designated region, in accordance with the feature quantity of the designated region;
setting a second representative position, which is a representative position of an outside region, the outside region being a region outside the designated region; and
detecting the designated region by using the first representative position and the second representative position.

8. An image processing system comprising:
a display apparatus that displays an image;
an image processing apparatus that performs image processing on image information about the image displayed on the display apparatus; and
an input apparatus that is used by a user to input, to the image processing apparatus, an instruction to perform image processing,
the image processing apparatus including
an image information obtaining unit that obtains the image information about the image,
a position information obtaining unit that obtains position information about an inclusive region input by the user and including a designated region, the designated region being a specific image region in the image,
a first representative position setting unit that acquires a feature quantity of the designated region from image information about the inclusive region and sets a first representative position, which is a representative position of the designated region, in accordance with the feature quantity of the designated region,
a second representative position setting unit that sets a second representative position, which is a representative position of an outside region, the outside region being a region outside the designated region,
a region detecting unit that detects the designated region by using the first representative position and the second representative position, and
an image processing unit that performs image processing on the designated region and/or the outside region.

9. A non-transitory computer readable medium storing a program causing a computer to execute a process, the process comprising:
obtaining image information about an image;
obtaining position information about an inclusive region input by a user and including a designated region, the designated region being a specific image region in the image;
acquiring a feature quantity of the designated region from image information about the inclusive region and setting a first representative position, which is a representative position of the designated region, in accordance with the feature quantity of the designated region;
setting a second representative position, which is a representative position of an outside region, the outside region being a region outside the designated region; and
detecting the designated region by using the first representative position and the second representative position.
